(19) United States
(12) Patent Application Publication
(10) Pub. No.: US 2026/0175499 A1
(43) Pub. Date: Jun. 25, 2026

(54) MOLDING MANAGEMENT SYSTEM

(71) Applicant: SEIKO EPSON CORPORATION, Tokyo (JP)

(72) Inventors: Yuji SAITO, MATSUMOTO-SHI (JP); Tatsuo AKASAKA, AZUMINO-SHI (JP); Tomohiro TAKIZAWA, MATSUMOTO-SHI (JP)

(21) Appl. No.: 19/427,004

(22) Filed: Dec. 19, 2025

(30) Foreign Application Priority Data
Dec. 24, 2024 (JP) 2024-227103

(51) Int. Cl. B29C 45/76; B29C 45/17

(52) U.S. Cl. CPC B29C 45/76; B29C 45/1774; B29C 2945/76076

(57) ABSTRACT

A molding management system for managing production of a product in a production process including an injection molding process of the product performed by an injection molding apparatus includes an information processing device communicably connected to a terminal device, the information processing device acquires data including a plurality of types of information related to injection molding from the injection molding apparatus, displays a list of the data on a display unit in response to a first operation that is received, and fixes, in response to a second operation that is received, a position of first data designated by the second operation among the data included in the list at a first fixed position designated by the second operation, after the list is displayed on the display unit.

The present application is based on, and claims priority from JP Application Serial Number 2024-227103, filed Dec. 24, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product performed by an injection molding apparatus, has been studied and developed.

Here, a technique is known in which a captured image of a product determined to be a non-defective product among products injection-molded in the past by an injection molding apparatus and a captured image of a latest product injection-molded by the injection molding apparatus can be displayed side by side (see JP-A-2006-175619).

JP-A-2006-175619 is an example of the related art.

Here, in the technique as described in JP-A-2006-175619, data desired by a user cannot be compared side by side and a difference between the data cannot be efficiently extracted.

### SUMMARY

An aspect of the disclosure is a molding management system for managing production of a product in a production process including an injection molding process of the product performed by an injection molding apparatus, the molding management system includes an information processing device communicably connected to a terminal device, the information processing device acquires data including a plurality of types of information related to injection molding from the injection molding apparatus, displays a list of the data on a display unit in response to a first operation that is received, and fixes, in response to a second operation that is received, a position of first data designated by the second operation among the data included in the list at a first fixed position designated by the second operation, after the list is displayed on the display unit.

### BRIEF DESCRIPTION OF THE DRAWINGS

FIG. 1 is a diagram showing an example of a configuration of a molding management system 1.

FIG. 2 is a diagram showing an example of a search image P1.

FIG. 3 is a diagram showing a state of a search result display region R1 in which a search result list is displayed.

FIG. 4 is a diagram showing an example of a state after cycle data displayed in the search result list shown in FIG. 3 is scrolled upward relative to a frame W1.

FIG. 5 is a diagram showing an example of a state after a position of cycle data SD3 in the search result list shown in FIG. 4 is moved by a drag-and-drop.

FIG. 6 is a diagram illustrating a state in which the cycle data SD3, which is an example of first cycle data, is fixed at a first fixed position in the search result list shown in FIG. 3, and cycle data fixed at a second fixed position as second cycle data.

FIG. 7 is a diagram showing an example of an extraction condition reception image P2.

FIG. 8 is a diagram showing a first example of a state in which comparison target values are displayed in the search result list according to a display rule RL0 after the first cycle data is fixed at the first fixed position.

FIG. 9 is a diagram showing a second example of the state in which the comparison target values are displayed in the search result list according to the display rule RL0 after the first cycle data is fixed at the first fixed position.

FIG. 10 is a diagram showing a third example of the state in which the comparison target values are displayed in the search result list according to the display rule RL0 after the first cycle data is fixed at the first fixed position.

FIG. 11 is a diagram showing a fourth example of the state in which the comparison target values are displayed in the search result list according to the display rule RL0 after the first cycle data is fixed at the first fixed position.

FIG. 12 is a diagram showing a fifth example of the state in which the comparison target values are displayed in the search result list according to the display rule RL0 after the first cycle data is fixed at the first fixed position.

FIG. 13 is a diagram showing a first example of a state in which the comparison target values are displayed in the search result list according to a combination of a display rule RL01 and a display rule RL02 after the first cycle data is fixed at the first fixed position.

FIG. 14 is a diagram showing an example of a state in which first comparison target values are displayed according to a first display rule RL1 and second comparison target values are displayed according to a second display rule RL2 in the search result list after the first cycle data is fixed at the first fixed position and the second cycle data is fixed at the second fixed position.

FIG. 15 is a diagram showing an example of a state in which the comparison target values are displayed in the search result list according to a third display rule RL3 after the first cycle data is fixed at the first fixed position and the second cycle data is fixed at the second fixed position.

FIG. 16 is a diagram showing an example of a hardware configuration of an information processing device X.

FIG. 17 is a diagram showing an example of a functional configuration of the information processing device X.

FIG. 18 is a diagram showing an example of a flow of processing performed by the information processing device X in response to a received operation.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. The information processing device is communicably connected to a terminal device. The information processing device acquires data including a plurality of types of information related to injection molding from the injection molding apparatus. Then, the information processing device displays a list of the data on a display unit in response to a first operation that is received, and fixes, in response to a second operation that is received, a position of first data designated by the second operation among the data included in the list at a first fixed position designated by the second operation, after the list is displayed on the display unit. Accordingly, the molding management system can easily change a combination of the information displayed on the display unit to a combination desired by the user according to a use.

In the following description, a configuration of the molding management system according to such an embodiment and processing performed by a server provided in the molding management system will be described in detail. In the present embodiment, when a certain piece of information X1 and another piece of information X2 are different information, a type of the information X1 is treated as different from a type of the information X2. That is, in the present embodiment, a certain piece of data including a plurality of pieces of different information means the data including a plurality of types of information. In the present embodiment, when it is necessary to distinguish colors of numerals in the drawing, the colors of the numerals are represented by Chinese characters in parentheses attached to the respective numerals. For example, in the present embodiment, in this case, a numeral “15” in the drawing indicates a red numeral, and thus is described as “15 (red)” in the drawing. Further, for example, in the present embodiment, in this case, a numeral “13” in the drawing indicates a black numeral, and thus is described as “13 (black)” in the drawing. Further, for example, in the present embodiment, in this case, a numeral “17” in the drawing indicates a green numeral, and thus is described as “17 (green)” in the drawing. In the present embodiment, when it is unnecessary to distinguish the colors of the numerals in the drawing, Chinese characters in parentheses attached to the respective numerals are omitted.

### Configuration of Molding Management System

Hereinafter, the configuration of the molding management system according to the embodiment will be described by taking a molding management system 1 as an example.

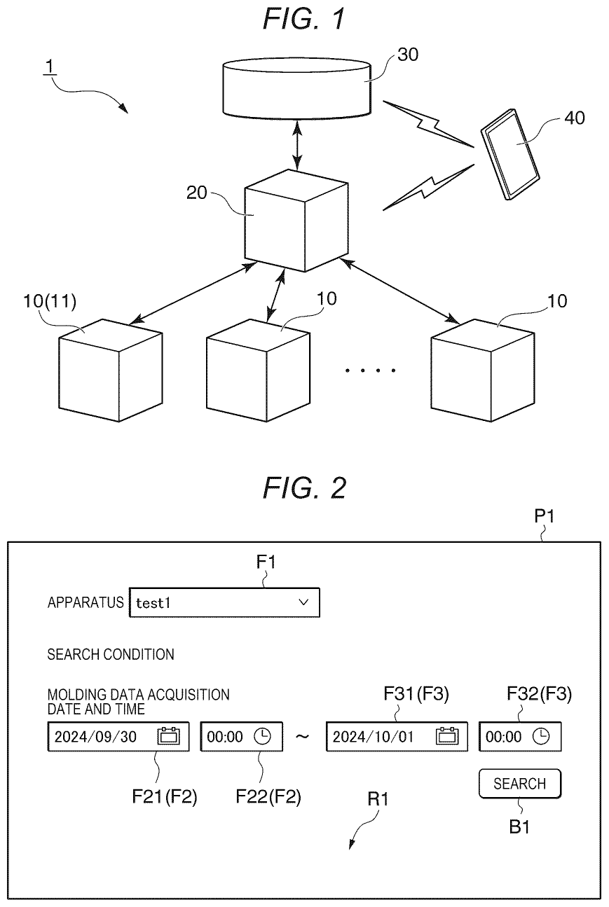

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. Further, the molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The cleaning device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding process of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a process in which the injection molding apparatus performs injection molding of a product once is referred to as a cycle. Hereinafter, for convenience of description, a cavity in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes a material used for injection molding of a product into the cavity in the mold attached to the injection molding apparatus in the injection molding process. The extrusion unit is, for example, a screw that moves a position in a cylinder back and forth by rotating in the cylinder. Instead of the screw, the extrusion unit may be a member that moves the position in the cylinder back and forth by a hydraulic pressure, a linear actuator, or the like. The material is extruded from an injection port of the cylinder toward the cavity in the mold in response to advance of the extrusion unit in the cylinder. Hereinafter, for convenience of description, the extrusion unit in the injection molding apparatus is referred to as a screw.

Further, M detection units are attached to the one or more injection molding apparatuses in the plurality of managed devices 10. M may be any integer equal to or greater than 2. The M detection units detect a quantity controlled by the injection molding apparatus in each cycle. The quantity controlled by the injection molding apparatus in each cycle is, for example, a part or all of a position of the screw, a rotation speed of the screw, an injection speed, an injection holding pressure, a cycle time, a measurement time, an apparatus temperature, a mold temperature, and a filling time, but is not limited thereto. Hereinafter, for convenience of description, the quantity detected by each of the M detection units attached to each of the one or more injection molding apparatuses in the plurality of managed devices 10 is simply referred to as a detection quantity. The injection speed is a speed at which the injection molding apparatus injects the material into the cavity in the mold by the screw. The injection holding pressure is a pressure in the mold held by the screw. The cycle time is a time required to execute one cycle. The measurement time is a time required for measurement in the cycle. The apparatus temperature is a temperature of the injection molding apparatus. The mold temperature is a temperature in the mold. The filling time is a time required to fill the cavity of the mold with the material. Here, a detection unit that detects a certain detection quantity among the M detection units attached to a certain injection molding apparatus is, for example, a sensor that detects the detection quantity, but is not limited thereto. The M detection units may include a detection unit that detects a quality of the product. This is because the quality of the product is also controlled by the injection molding apparatus in each cycle. In this case, the detection unit is, for example, a device that includes an imaging unit capable of imaging the product to detect the quality of the product, but is not limited thereto. In this case, for example, a value of the detection quantity indicating the quality of the product detected by the detection unit is, for example, any of a plurality of predetermined values arranged in descending order of quality, but is not limited thereto.

The information processing device 20 acquires various data such as cycle data, injection molding condition data, and operation state history data from each of the one or more injection molding apparatuses in the plurality of managed devices 10. Hereinafter, in order to simplify the description, as an example, a case in which two types of data, including the cycle data and the injection molding condition data are acquired by the information processing device 20 from each of the one or more injection molding apparatuses will be described. The information processing device 20 independently acquires each of the two types of data. Therefore, in this example, timings at which these two types of data are acquired by the information processing device 20 are different from each other, except for a case in which the timings accidentally match each other, unless the timings are intentionally matched.

The information processing device 20 acquires the cycle data for each cycle from each of the one or more injection molding apparatuses in the plurality of managed devices 10. More specifically, the information processing device 20 acquires the cycle data from each of the one or more injection molding apparatuses every time each cycle ends. Hereinafter, for convenience of description, the cycle data acquired when a certain cycle ends is referred to as cycle data of the cycle. Hereinafter, for convenience of description, a cycle that ends when certain cycle data is acquired is referred to as a cycle of the cycle data.

The cycle data acquired from a certain injection molding apparatus in a certain cycle includes a plurality of types of information. Specifically, the cycle data includes a plurality of pieces of cycle-related information obtained in response to execution of the cycle by the injection molding apparatus, apparatus identification information for identifying the injection molding apparatus, and first date-and-time information indicating a date and time when the cycle data is acquired by the information processing device 20 from the injection molding apparatus. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the date and time. The cycle data may include other information in addition to the plurality of pieces of cycle-related information, the apparatus identification information, and the first date-and-time information. The apparatus identification information may be included in the cycle data as any piece of the plurality of pieces of cycle-related information. Hereinafter, as an example, a case in which the apparatus identification information is included in the cycle data as any piece of the plurality of pieces of cycle-related information will be described.

The plurality of pieces of cycle-related information included in the cycle data acquired from a certain injection molding apparatus in a certain cycle includes N pieces of actual value information in addition to the apparatus identification information for identifying the injection molding apparatus. N may be any integer equal to or greater than 2. Each of the N pieces of actual value information is information indicating one or more types of actual values for each detection quantity controlled by the injection molding apparatus. Here, each of the one or more types of actual values for a certain detection quantity indicates a feature of a waveform indicating a temporal change in a value of the detection quantity, and is, for example, a minimum value of the detection quantity, a maximum value, an average value, a variance, a standard deviation, a start value of a period in which the detection quantity is detected, or an end value of the period, but is not limited thereto. For example, an actual value of the injection speed, which is an example of the detection quantity, is a maximum injection speed which is a maximum value of the injection speed, an average injection speed which is an average value of the injection speed, or the like, but is not limited thereto. Further, for example, an actual value of the injection holding pressure, which is an example of the detection quantity, is a maximum injection holding pressure which is a maximum value of the injection holding pressure, an average injection holding pressure which is an average value of the injection holding pressure, or the like, but is not limited thereto. Further, for example, an actual value of a position of the screw, which is an example of the detection quantity, is an injection start position which is a position of the screw when the injection of the material is started in the injection molding process of the cycle, an injection end position which is a position of the screw when the injection of the material is ended in the injection molding process of the cycle, a V-P switching position which is a position of the screw for switching from speed control for controlling the position of the screw while keeping the injection speed constant to pressure control for controlling the position of the screw while keeping the injection holding pressure constant, or the like, but is not limited thereto. An actual value for a certain detection quantity may be a value of the detection quantity itself. For example, an actual value of the cycle time, which is an example of the detection quantity, is a value of the cycle time itself. Further, for example, an actual value of the filling time, which is an example of the detection quantity, is a value of the filling time itself. One or more types of actual values for a certain detection quantity are values controlled by the injection molding apparatus because the detection quantity is a quantity controlled by the injection molding apparatus.

Further, the plurality of pieces of cycle-related information included in the cycle data acquired from a certain injection molding apparatus in a certain cycle may include M pieces of time-series information in addition to the apparatus identification information for identifying the injection molding apparatus and the N pieces of actual value information. Each of the M pieces of time-series information is information indicating a time series of any of M detection quantities. When the M pieces of time-series information are included in the plurality of pieces of cycle-related information, the plurality of pieces of cycle-related information may not include the N pieces of actual value information. This is because the information processing device 20 can calculate the actual value indicated by each of the N pieces of actual value information from the M pieces of time-series information. In this case, the M pieces of time-series information are treated as substitutes for the N pieces of actual value information. That is, in this case, in the information processing device 20, the actual value information indicating each of one or more types of actual values for a certain detection quantity is time-series information indicating a time series of the detection quantity. Hereinafter, as an example, a case in which the plurality of pieces of cycle-related information includes M pieces of time-series information and N pieces of actual value information will be described.

The plurality of pieces of cycle-related information included in the cycle data acquired from a certain injection molding apparatus in a certain cycle may include other information. The other information is, for example, a part or all of the operation state information, product quantity information, job number information, or cycle count information, but is not limited thereto. Here, the operation state information included in the cycle data as the cycle-related information is information indicating an operation state of the injection molding apparatus. The product quantity information included in the cycle data as the cycle-related information is information indicating the number of products injection-molded by the injection molding apparatus in the cycle. The job number information is information indicating a job number for identifying a job to which a cycle to be executed belongs. The cycle count information is information indicating a cycle count. The cycle count is a number indicating an order in which the cycle is executed.

The cycle data as described above can be distinguished by a combination of the apparatus identification information and the first date-and-time information. When there is only one injection molding apparatus coupled to the information processing device 20, the cycle data may not include the apparatus identification information. This is because, in this case, the cycle data can be distinguished simply by the first date-and-time information.

When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires the injection molding condition data from each of the one or more injection molding apparatuses in the plurality of managed devices 10 every time an injection molding condition is set in the injection molding apparatus.

Here, the injection molding condition data acquired from a certain injection molding apparatus is information in which a plurality of pieces of injection molding condition information each indicating the injection molding condition set in the injection molding apparatus, the apparatus identification information for identifying the injection molding apparatus, and second date-and-time information indicating a date and time when the injection molding condition data is acquired by the information processing device 20 from the injection molding apparatus are associated with one another. The apparatus identification information is, for example, an ID for identifying the injection molding apparatus, but may be other information through which the injection molding apparatus can be identified, such as an IP address assigned to the injection molding apparatus. The second date-and-time information may be a time stamp or other information indicating the date and time. The injection molding condition data may include other information in addition to the plurality of pieces of injection molding condition information, the apparatus identification information, and the second date-and-time information. The apparatus identification information may be included in the injection molding condition data as any piece of the plurality of pieces of injection molding condition information. Hereinafter, as an example, a case in which the apparatus identification information is included in the injection molding condition data as any piece of the plurality of pieces of injection molding condition information will be described.

The plurality of pieces of injection molding condition information included in the injection molding condition data acquired from a certain injection molding apparatus include M pieces of target value information in addition to the apparatus identification information for identifying the injection molding apparatus. Each of the M pieces of target value information is information indicating one or more target values in the control for each detection quantity performed by the injection molding apparatus. Therefore, the target value information indicating one or more target values for a certain detection quantity is associated with the detection quantity. A method of associating the detection quantity with the target value information may be a known method or a method to be developed in the future. A reason why the M pieces of target value information are included in the injection molding condition data as the injection molding condition information is that the injection molding apparatus controls the detection quantity such that the value of the detection quantity matches the target value of the detection quantity for each detection quantity in each cycle. Here, a reason why there are one or more target values for each detection quantity is that there may be a plurality of target values as targets to which each detection quantity is to be brought close in the control performed by the injection molding apparatus in each cycle. For example, the injection speed, which is an example of the detection quantity, changes in a plurality of stages in the injection molding process of each cycle. In such a case, there are a plurality of target values for the detection quantity. The target value information for a certain detection quantity indicates each of the one or more target values for the detection quantity. Therefore, the injection molding condition data includes, as the injection molding condition information, the target value information of the same pieces as the number of detection units attached to the injection molding apparatus. Hereinafter, for convenience of description, each of the one or more target values for a certain detection quantity is referred to as a target value corresponding to the detection quantity. Therefore, hereinafter, for convenience of description, the detection quantity is referred to as a detection quantity corresponding to the one or more target values.

The plurality of pieces of injection molding condition information included in the injection molding condition data acquired from a certain injection molding apparatus may include other information in addition to the apparatus identification information for identifying the injection molding apparatus and the M pieces of target value information. The other information is abnormality determination condition information associated with each target value set as the injection molding condition in the injection molding apparatus or the like, but is not limited thereto. Here, the abnormality determination condition information associated with a certain target value is information indicating an abnormality determination condition satisfied by a value of a detection quantity corresponding to the target value when no abnormality occurs in the value of the detection quantity in the control in which the injection molding apparatus causes the value of the detection quantity to match the target value. A method of associating the target value with the abnormality determination condition information may be a known method or a method to be developed in the future. The abnormality determination condition may be any condition as long as the condition is satisfied by the value of the detection quantity when no abnormality occurs in the value of the detection quantity in the control.

The injection molding condition data as described above can be distinguished by a combination of the apparatus identification information and the second date-and-time information. When there is only one injection molding apparatus coupled to the information processing device 20, the injection molding condition data may not include the apparatus identification information. This is because, in this case, each piece of injection molding condition data can be distinguished simply by the second date-and-time information.

When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30. Here, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed in the future. By such association, at least one piece of injection molding condition data is associated with each piece of cycle data. Hereinafter, as an example, a case in which one piece of injection molding condition data is associated with each piece of cycle data will be described. The injection molding condition data may not be associated with each piece of cycle data.

In response to a request from the terminal device communicably connected to the information processing device 20, the information processing device 20 displays, on a display unit of the terminal device, various images based on injection molding-related data stored in the information processing device 20. Here, the images are a graphical user interface (GUI), an icon, a window on an operating system (OS), and the like. Hereinafter, as an example, a case in which the information processing device 20 is communicably connected to the terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing in response to a received operation means the information processing device 20 performing the processing in response to an operation received from the terminal device 40 via the image displayed on the terminal device 40.

Examples of the information processing device 20 include, but are not limited to, a workstation, a desktop personal computer (PC), and a notebook PC. The information processing device 20 is communicably connected to each of the plurality of managed devices 10 by wired or wireless communication. Examples of a communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the data stored in the server 30. The data may be cycle data, injection molding condition data, both of these two types of data, or other data. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing in response to a received operation means the server 30 performing the processing in response to an operation received from the terminal device 40 via the image displayed on the terminal device 40.

As described above, in the molding management system 1, both the information processing device 20 and the server 30 display, in response to the received operation, various images based on the stored data on the display unit of the terminal device 40. Therefore, hereinafter, for convenience of description, the information processing device 20 and the server 30 are collectively referred to as an information processing device X unless it is necessary to distinguish the information processing device 20 and the server 30. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

Here, the information processing device X displays, in response to a received operation, a search image for searching for one or more pieces of data desired by a user among the one or more pieces of data stored in the information processing device X. The data to be searched for in the search image may be the cycle data, the injection molding condition data, or other data. For example, the information processing device X displays, in response to a received operation, a search image for searching for one or more pieces of cycle data desired by the user among the one or more pieces of cycle data stored in the information processing device X. Further, for example, the information processing device X displays, in response to a received operation, a search image for searching for one or more pieces of injection molding condition data desired by the user among the one or more pieces of injection molding condition data stored in the information processing device X. Further, for example, the information processing device X displays, in response to a received operation, a search image for searching for one or more pieces of other data desired by the user among the one or more pieces of other data stored in the information processing device X. Hereinafter, details of the processing performed by the information processing device X on the search image will be described by taking processing performed by the information processing device X on a search image P1 as an example. The search image P1 is an example of the image for receiving an operation of searching for one or more pieces of cycle data desired by the user among the one or more pieces of cycle data stored in the information processing device X. More specifically, the search image P1 is an image for receiving various types of information that can be used as a search key for searching for the one or more pieces of cycle data desired by the user. Hereinafter, in order to simplify the description, as an example, a case will be described in which the search image P1 can receive, as the search key, each of the apparatus identification information for identifying the injection molding apparatus that outputs the cycle data and period information indicating a period including the date and time when the cycle data is acquired by the information processing device 20.

FIG. 2 is a diagram showing an example of the search image P1. In the example shown in FIG. 2, the search image P1 includes an input field F1, an input field F2, an input field F3, a button B1, and a search result display region R1. The search image P1 may include another graphical user interface (GUI) capable of receiving an operation of searching for the cycle data instead of a part or all of these GUIs or in addition to all of these GUIs. Hereinafter, for convenience of description, various operations received by the information processing device X via the search image P1 are collectively referred to as search operations. Each of the search operations is an example of the first operation.

The input field F1 is a field for inputting the apparatus identification information for identifying the injection molding apparatus that outputs the cycle data desired by the user. In the example shown in FIG. 2, “test 1” is input to the input field F1 as an example of the apparatus identification information. The apparatus identification information may be input to the input field F1 by selecting the apparatus identification information from a pull-down menu or may be directly input using an input device such as a keyboard.

The input field F2 and the input field F3 are fields for inputting the period information indicating a period including a date and time desired by the user to acquire the cycle data via the information processing device 20. In the example shown in FIG. 2, the input field F2 is a field for inputting start date-and-time information indicating a date and time when the period starts. In this example, the input field F3 is a field for inputting end date-and-time information indicating a date and time when the period ends.

More specifically, the input field F2 includes two input fields, that is, an input field F21 and an input field F22. The input field F21 is a field for inputting start date information indicating a date in the date and time indicated by the start date-and-time information. In the example shown in FIG. 2, in the input field F21, “2024 Sep. 30” indicating Sep. 30, 2024 is input as an example of the start date information. The start date information may be input to the input field F21 by selecting information from a pull-down menu, may be input by selecting a date from an image indicating a calendar, or may be directly input using an input device such as a keyboard. Meanwhile, the input field F22 is a field for inputting start time information indicating a time in the date and time indicated by the start date-and-time information. In the input field F22, “00:00” indicating zero o'clock is input as an example of the start time information. The start time information may be input to the input field F22 by selecting information from a pull-down menu, may be input by designating a time on an image indicating a clock, or may be directly input using an input device such as a keyboard.

The input field F3 includes two input fields, that is, an input field F31 and an input field F32. The input field F31 is a field for inputting end date information indicating a date in the date and time indicated by the end date-and-time information. In the example shown in FIG. 2, in the input field F31, “2024 Oct. 1” indicating Oct. 1, 2024 is input as an example of the end date information. The end date information may be input to the input field F31 by selecting information from a pull-down menu, may be input by selecting a date from an image indicating a calendar, or may be directly input using an input device such as a keyboard. Meanwhile, the input field F32 is a field for inputting end time information indicating a time in the date and time indicated by the end date-and-time information. In the input field F32, “00:00” indicating zero o'clock is input as an example of the end time information. The end time information may be input to the input field F32 by selecting information from a pull-down menu, may be input by designating a time on an image indicating a clock, or may be directly input using an input device such as a keyboard.

The button B1 is a button for receiving an operation of using each piece of information input to a part or all of the input field F1 to the input field F3 as the search key to search for the cycle data based on the search key. That is, when a selection operation on the button B1 is received, the information processing device X extracts, as a search result, one or more pieces of cycle data corresponding to the respective pieces of information input to a part or all of the input field F1 to the input field F3. Then, the information processing device X displays a list of the extracted one or more pieces of cycle data in the search result display region R1. In the present embodiment, the selection operation means a click, a tap, or the like, but is not limited thereto. The search image P1 shown in FIG. 2 is an image before the one or more pieces of cycle data are extracted. Therefore, nothing is displayed in the search result display region R1 shown in FIG. 2. Hereinafter, for convenience of description, the list of one or more pieces of cycle data extracted by the information processing device X is simply referred to as a search result list. A method of extracting one or more pieces of cycle data corresponding to the respective pieces of information input to a part or all of the input field F1 to the input field F3, that is, a method of searching for the one or more pieces of cycle data may be a known method or a method to be developed in the future. Therefore, in the present embodiment, a detailed description of the extraction method will be omitted. The information processing device X may be configured to, when no information is input to all of the input field F1 to the input field F3 and a selection operation is performed on the button B1, display a list of all of the one or more pieces of cycle data stored in advance in the search result display region R1 as the search result list, or display nothing in the search result display region R1.

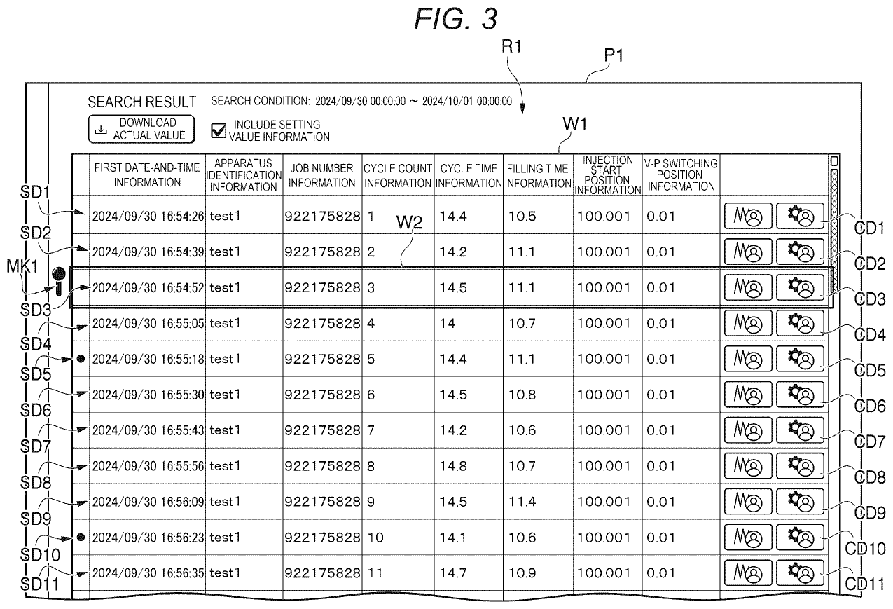

FIG. 3 is a diagram showing a state of the search result display region R1 in which the search result list is displayed. In the example shown in FIG. 3, in the search result display region R1, a search result list including a plurality of pieces of cycle data extracted by the search of the cycle data based on the search key described above is displayed. That is, in this example, each record included in the search result list indicates any one of the plurality of pieces of cycle data. In this example, only 11 pieces of cycle data among the plurality of pieces of cycle data are displayed in a frame W1 of the search result list. This is because the number of pieces of cycle data extracted by the search of the cycle data based on the search key is too large to fit in the frame W1 of the search result list. By scrolling the cycle data displayed in the frame W1 upward or downward relative to the frame W1, the user can sequentially display, in the frame W1, all the cycle data included in the search result list. Hereinafter, for convenience of description, the 11 pieces of cycle data displayed in the frame W1 of the search result list shown in FIG. 3 are referred to as cycle data SD1, cycle data SD2, . . . , and cycle data SD11, as shown in FIG. 3.

Here, in the example shown in FIG. 3, in addition to the first date-and-time information and the apparatus identification information, all the cycle data included in the search result list includes actual value information such as the job number information indicating a job number, the cycle count information indicating the cycle count, cycle time information indicating a cycle time, filling time information indicating a filling time, injection start position information indicating an injection start position, and V-P switching position information indicating a V-P switching position as the cycle-related information. In other words, in this example, in addition to the first date-and-time information and the apparatus identification information, the record in which each piece of all the cycle data included in the search result list is shown includes the actual value information such as the job number information, the cycle count information, the cycle time information, the filling time information, the injection start position information, and the V-P switching position information as the cycle-related information. Therefore, the 11 pieces of cycle data displayed in the search result list shown in FIG. 3 also include the job number information, the cycle count information, the cycle time information, the filling time information, the injection start position information, the V-P switching position information, and the like as the cycle-related information in addition to the first date-and-time information and the apparatus identification information. Types of one or more pieces of information included in the record, in which each piece of cycle data in the search result list is shown, may be designated by the user or may be determined in advance.

Further, the record, in which each of the plurality of pieces of cycle data included in the search result list is shown, further includes association information indicating the injection molding condition data associated with the cycle data indicated by the record. Therefore, in the search result list shown in FIG. 3, a record in which cycle data SDi is shown includes association information CDi. Here, i represents any one of 1 to 11. The association information CDi is association information indicating the injection molding condition data associated with the cycle data SDi. When displaying the search result list in the search result display region R1, the information processing device X displays, in each record included in the search result list, the association information indicating the injection molding condition data associated with the cycle data indicated by the record. Accordingly, the information processing device X can make it possible to easily grasp a relation between the cycle of injection molding in the injection molding apparatus and the injection molding condition set in the injection molding apparatus. In the example shown in FIG. 3, the association information indicating the injection molding condition data associated with a corresponding piece of cycle data is an image not including the injection molding condition data itself. Therefore, in this example, the user cannot visually grasp the injection molding condition data associated with the corresponding piece of cycle data simply by the information displayed in the search result list shown in FIG. 3. Therefore, as described above, each piece of association information may include at least a part of the injection molding condition data indicated by the association information. In this case, the user can visually grasp the injection molding condition data associated with the corresponding piece of cycle data simply by the information displayed in the search result list. As a result, the information processing device X can make it possible to more reliably and easily grasp the relation between the cycle of injection molding in the injection molding apparatus and the injection molding condition set in the injection molding apparatus.

Here, in the example shown in FIG. 3, each of association information CD1 to association information CD11 is an image for receiving an operation of outputting the injection molding condition data indicated by a corresponding piece of the association information to another device. The same applies to other pieces of cycle data included in the search result list. The other device may be, for example, the terminal device 40 or another information processing device communicably connected to the information processing device X. For example, when a selection operation on the association information CD1 is received, the information processing device X outputs the injection molding condition data associated with the cycle data SD1 to the terminal device 40 as the injection molding condition data indicated by the association information CD1. Accordingly, the user can easily download the injection molding condition data to the terminal device 40. The same applies to the association information displayed in association with other pieces of cycle data. By outputting the injection molding condition data to the terminal device 40 by an operation on the association information in this way, when the user wants to acquire desired injection molding condition data, it is not necessary to search for the desired injection molding condition data from among many pieces of injection molding condition data, and the desired injection molding condition data can be easily acquired. This prevents the user from acquiring erroneous injection molding condition data and is useful. For example, the information processing device X outputs the injection molding condition data to the terminal device 40 as a CSV (Comma Separated Values) file, but is not limited thereto.

As shown in FIG. 3, when displaying the search result list in the search result display region R1, the information processing device X displays the search result list in the search result display region R1 such that the cycle data is arranged in order of the date and time indicated by the first date-and-time information included in the cycle data. Specifically, in the search result list shown in FIG. 3, the 11 pieces of cycle data are displayed in descending order of the date and time. Accordingly, the information processing device X can make it possible to confirm the plurality of pieces of cycle data displayed in the search result list in chronological order. In the search result list, the plurality of pieces of cycle data may be displayed in ascending order of the date and time.

After the search result list is displayed in the search result display region R1 of the search image P1, the information processing device X specifies the cycle data desired by the user in response to the received operation, and fixes a position of the specified cycle data at a position designated by the operation. For example, after the search result list is displayed, when a selection operation for any piece of the cycle data included in the search result list is received as a first position fixing operation, the information processing device X specifies the cycle data for which the first position fixing operation is received as first cycle data, and specifies a position of the first cycle data at a time point when the first position fixing operation is received as a first fixed position. In other words, in this case, the information processing device X specifies the cycle data for which the first position fixing operation is received as the first cycle data, and specifies a position where the first cycle data is displayed immediately before the first position fixing operation is received as the first fixed position. Then, the information processing device X fixes the position of the first cycle data at the specified first fixed position. The first position fixing operation is an example of the second operation. The position of the first cycle data at the time point when the first position fixing operation is received is an example of the first fixed position designated by the second operation.

In the example shown in FIG. 3, the cycle data SD3 is an example of the cycle data for which the first position fixing operation is received. Therefore, an image MK1 indicating that the cycle data SD3 is designated as the first cycle data is displayed in a record in which the cycle data SD3 is shown. A position of the cycle data SD3 shown in FIG. 3 coincides with a position of the cycle data SD3 at a time point when the first position fixing operation is received. Therefore, in this example, the information processing device X specifies the position of the cycle data SD3 shown in FIG. 3 as the first fixed position, and fixes the cycle data SD3 at the specified first fixed position. The position of the cycle data SD3 fixed in this way does not change even when the cycle data displayed in the frame W1 is scrolled upward or downward relative to the frame W1. In other words, a relative position of the first fixed position relative to the frame W1 of the search result list does not change even when the cycle data displayed in the frame W1 is scrolled upward or downward relative to the frame W1. In FIG. 3, the first fixed position is indicated by a frame W2 surrounding the cycle data SD3.

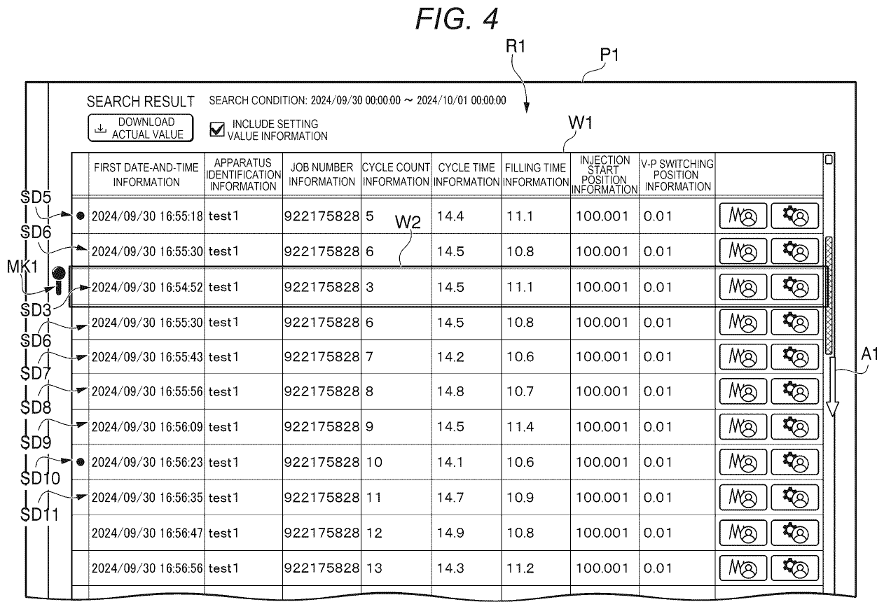

FIG. 4 is a diagram showing an example of a state after the cycle data displayed in the search result list shown in FIG. 3 is scrolled upward relative to the frame W1. More specifically, FIG. 4 is a diagram showing an example of the search result list after the cycle data is scrolled until the cycle data displayed in an uppermost row in the search result list shown in FIG. 3 changes from the cycle data SD1 to the cycle data SD5. An arrow A1 shown in FIG. 4 indicates a direction in which the user moves a slide bar to scroll the cycle data in the search result list shown in FIG. 4.

As shown in FIG. 4, even when the cycle data is scrolled in the search result list, the information processing device X does not change the position of the cycle data SD3 specified as the first cycle data from the specified first fixed position. Accordingly, the information processing device X can fix the cycle data desired by the user at a position desired by the user. This means that the user can visually and easily compare the desired cycle data by using the search result list together with scrolling. This is because, after the position of the first cycle data is fixed at the first fixed position, the user can scroll the cycle data in the search result list such that the desired cycle data to be compared with the first cycle data is located near the first cycle data. That is, the information processing device X can make it possible to efficiently compare the desired data. Further, since each reference value is prevented from becoming invisible due to the scrolling in the search result list, it is possible to prevent the user from losing sight of the reference value in the comparison between the cycle data.

In the example shown in FIG. 4, when a position of a certain piece of cycle data is overlapped with the position of the first cycle data in the scrolling of the cycle data, the information processing device X displays the cycle data such that the first cycle data is sandwiched by the cycle data from above and below. Therefore, in FIG. 4, the cycle data SD6 sandwiches the cycle data SD3, which is an example of the first cycle data, from above and below. Accordingly, the user can easily and visually compare the first cycle data and the desired cycle data to be compared with the first cycle data. However, the information processing device X may be configured not to sandwich the first cycle data with other cycle data.

In the example shown in FIGS. 3 and 4, the record, in which the cycle data SD3, which is an example of the first cycle data, is shown, is sandwiched between records indicating other pieces of cycle data, and may be difficult to visually recognize even if the image MK1 is displayed. Therefore, after the first cycle data is fixed at the first fixed position, the information processing device X changes the first fixed position in the search result list in response to a received position moving operation. The position moving operation may be any operation as long as being an operation capable of moving the position of the cycle data, such as a drag-and-drop. Hereinafter, a case in which the position moving operation is a drag-and-drop will be described as an example.

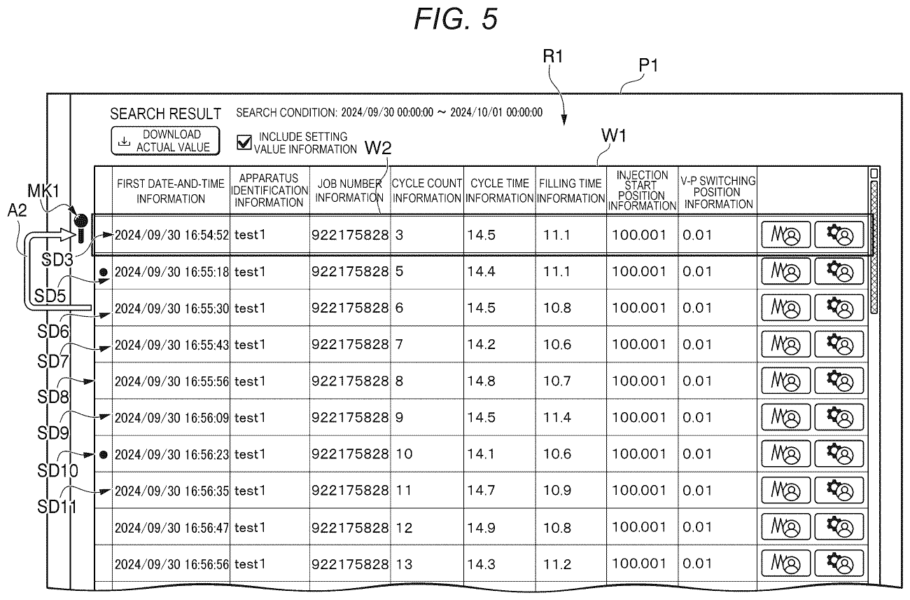

FIG. 5 is a diagram showing an example of a state after the position of the cycle data SD3 in the search result list shown in FIG. 4 is moved by a drag-and-drop. An arrow A2 shown in FIG. 5 indicates a moving destination to which the cycle data SD3 is moved by the drag-and-drop in the search result list shown in FIG. 5. The user can move the cycle data SD3, which is an example of the first cycle data fixed at the first fixed position, to a position desired by the user in the search result list by a drag-and-drop, which is an example of the position moving operation. In other words, as shown in FIG. 5, the user can move the cycle data SD3 to a line desired by the user in the search result list by a drag-and-drop. This is a result of the information processing device X moving the first fixed position and the position of the cycle data SD3 by the drag-and-drop, which is an example of the position moving operation. Such movement of the first fixed position is implemented by the information processing device X when receiving the position moving operation. The information processing device X may be configured to move the first fixed position to a position outside the search result list by the received position moving operation. In this case, the cycle data SD3 displayed outside the search result list may be displayed on the search image P1 by another window, may be displayed on the search image P1 as another image, or may be displayed at a position different from that on the search image P1 as another window or another image.

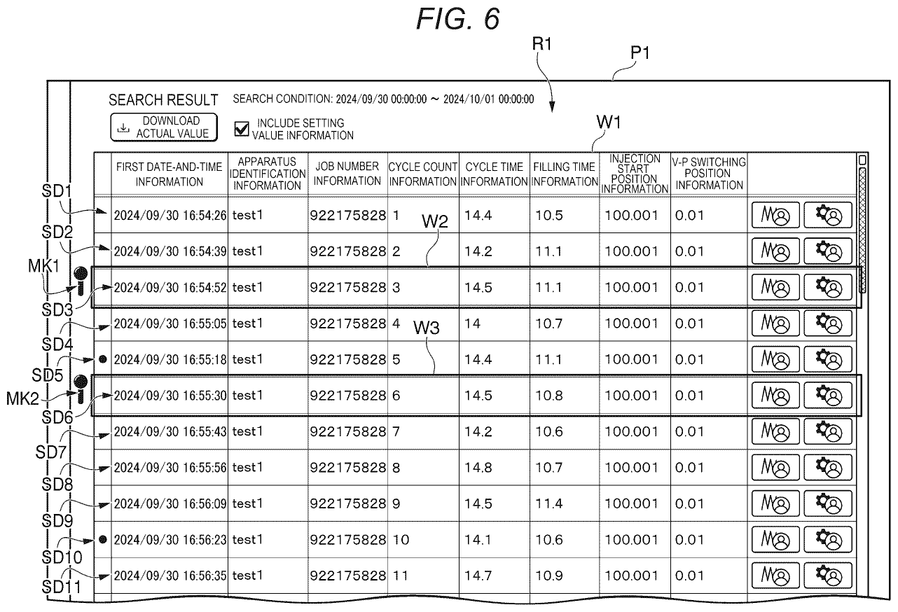

After the first cycle data is fixed at the first fixed position in the search result list, the information processing device X fixes, in response to a received second position fixing operation, a position of second cycle data designated by the second position fixing operation among the cycle data included in the search result list at a second fixed position designated by the second position fixing operation. However, the cycle data that can be designated as the second cycle data is one or more pieces of cycle data among the cycle data included in the search result list, excluding the first cycle data. Therefore, the second cycle data is cycle data different from the first cycle data. A position that can be fixed as the second fixed position is a position other than the first fixed position. That is, the second fixed position is a position different from the first fixed position. FIG. 6 is a diagram illustrating a state in which the cycle data SD3, which is an example of first cycle data, is fixed at the first fixed position in the search result list shown in FIG. 3, and the cycle data fixed at the second fixed position as the second cycle data.

For example, after the first cycle data is fixed at the first fixed position, when a selection operation for any piece of cycle data among the cycle data included in the search result list excluding the first cycle data is received as the second position fixing operation, the information processing device X specifies the cycle data for which the second position fixing operation is received as the second cycle data, and specifies a position of the second cycle data at a time point when the second position fixing operation is received as the second fixed position. Then, the information processing device X fixes the position of the second cycle data at the specified second fixed position. The second position fixing operation is an example of a fourth operation. The position of the second cycle data at the time point when the second position fixing operation is received is an example of the second fixed position designated by the fourth operation.

In the example shown in FIG. 6, the cycle data SD6 is an example of the cycle data for which the second position fixing operation is received. Therefore, an image MK2 indicating that the cycle data SD6 is designated as the second cycle data is displayed in a record in which the cycle data SD6 is shown. A position of the cycle data SD6 shown in FIG. 6 coincides with a position of the cycle data SD6 at a time point when the second position fixing operation is received. Therefore, in this example, the information processing device X specifies the position of the cycle data SD6 shown in FIG. 6 as the second fixed position, and fixes the cycle data SD6 at the specified second fixed position. The position of the cycle data SD6 fixed in this way also does not change even when the cycle data displayed in the frame W1 is scrolled upward or downward relative to the frame W1. In other words, a relative position of the second fixed position relative to the frame W1 of the search result list does not change even when the cycle data displayed in the frame W1 is scrolled upward or downward relative to the frame W1. In FIG. 6, the second fixed position is indicated by a frame W3 surrounding the cycle data SD6.

Further, the information processing device X can also move, by the position moving operation, the position of the cycle data fixed at the second fixed position as the second cycle data. For example, the user can move the position of the cycle data SD6, which is an example of the second cycle data, to a position desired by the user in the search result list by the drag-and-drop, which is an example of the position moving operation. In other words, the user can move the cycle data SD6 to a line desired by the user in the search result list by the drag-and-drop. Such movement of the second fixed position is also implemented by the information processing device X when receiving the position moving operation. Accordingly, for example, the user can cause the first cycle data and the second cycle data to be adjacent to each other, and as a result, the first cycle data and the second cycle data can be visually easily compared. That is, the information processing device X can make it possible to efficiently compare the desired data.

The information processing device X may be configured to fix a position of each of three or more pieces of cycle data in response to the received operation, by repeating the same processing as the processing of fixing the second cycle data at the second fixed position. For example, the information processing device X may be configured to fix the first cycle data at the first fixed position in response to the received first position fixing operation, fix the second cycle data at the second fixed position in response to the received second position fixing operation, and fix third cycle data at a third fixed position in response to a received third position fixing operation.

The information processing device X may be configured to, after the search result list is displayed, display, in response to a received extraction condition reception image display operation, an extraction condition reception image P2 for receiving an extraction condition for extracting, from the cycle data, desired cycle data whose position is fixed. In this case, for example, the information processing device X receives the extraction condition via the displayed extraction condition reception image P2, and specifies, as the first cycle data, the cycle data extracted according to the received extraction condition. That is, in this case, an extraction condition reception operation for receiving the extraction condition via the extraction condition reception image P2 is an example of the first position fixing operation. The extraction condition received via the extraction condition reception image P2 is, in other words, a search key. Therefore, the information processing device X searches for the cycle data to be extracted using the extraction condition received via the extraction condition reception image P2 as a search key.

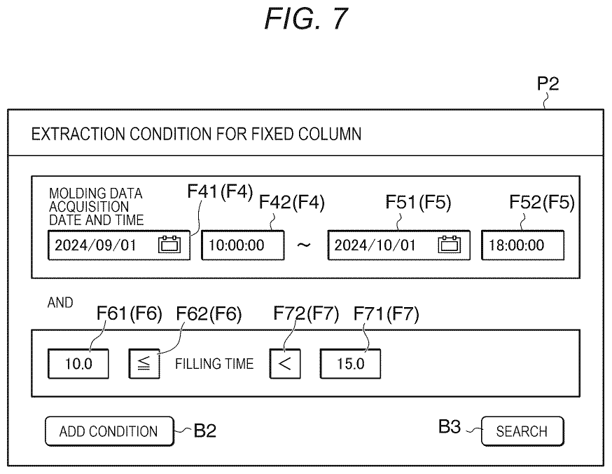

FIG. 7 is a diagram showing an example of the extraction condition reception image P2. The extraction condition reception image P2 includes an input field F4, an input field F5, an input field F6, an input field F7, a button B2, and a button B3. Instead of a part or all of these GUIs or in addition to all of these GUIs, the extraction condition reception image P2 may include another GUI capable of receiving the extraction condition. The extraction condition reception operation described above is a general term for a part or all of various operations received by the information processing device X via the extraction condition reception image P2.

The input field F4 and the input field F5 are fields for inputting the period information indicating a period including a date and time desired by the user to acquire the cycle data via the information processing device 20. In the example shown in FIG. 7, the input field F4 is a field for inputting start date-and-time information indicating a date and time when the period starts. In this example, the input field F5 is a field for inputting end date-and-time information indicating a date and time when the period ends. That is, the input field F4 has a configuration similar to the input field F2. The input field F5 has a configuration similar to the input field F3.

More specifically, the input field F4 includes two input fields, that is, an input field F41 and an input field F42. The input field F41 is a field for inputting start date information indicating a date in the date and time indicated by the start date-and-time information. In the example shown in FIG. 7, in the input field F41, “2024 Sep. 1” indicating Sep. 1, 2024 is input as an example of the start date information. The start date information may be input to the input field F41 by selecting information from a pull-down menu, may be input by selecting a date from an image indicating a calendar, or may be directly input using an input device such as a keyboard. Meanwhile, the input field F42 is a field for inputting start time information indicating a time in the date and time indicated by the start date-and-time information. In the input field F42, “10:00:00” indicating ten o'clock is input as an example of the start time information. The start time information may be input to the input field F42 by selecting information from a pull-down menu, may be input by designating a time on an image indicating a clock, or may be directly input using an input device such as a keyboard.

The input field F5 includes two input fields, that is, an input field F51 and an input field F52. The input field F51 is a field for inputting end date information indicating a date in the date and time indicated by the end date-and-time information. In the example shown in FIG. 7, in the input field F51, “2024 Oct. 1” indicating Oct. 1, 2024 is input as an example of the end date information. The end date information may be input to the input field F51 by selecting information from a pull-down menu, may be input by selecting a date from an image indicating a calendar, or may be directly input using an input device such as a keyboard. Meanwhile, the input field F52 is a field for inputting end time information indicating a time in the date and time indicated by the end date-and-time information. In the input field F52, “18:00:00” indicating six o'clock pm is input as an example of the end time information. The end time information may be input to the input field F52 by selecting information from a pull-down menu, may be input by designating a time on an image indicating a clock, or may be directly input using an input device such as a keyboard.

The input field F6 and the input field F7 are fields for inputting filling time range information indicating a filling time range including filling times desired by the user and indicated by the filling time information in the cycle data. In the example shown in FIG. 7, the input field F6 is a field for inputting filling time lower limit value information indicating a lower limit value of the filling time range. In this example, the input field F7 is a field for inputting filling time upper limit value information indicating an upper limit value of the filling time range.

The input field F6 includes two input fields, that is, an input field F61 and an input field F62. The input field F61 is a field for inputting the filling time lower limit value information. In the example shown in FIG. 7, in the input field F61, “10.0” indicating ten seconds is input as an example of the filling time lower limit value information. The filling time lower limit value information may be input to the input field F61 by selecting information from a pull-down menu, or may be directly input using an input device such as a keyboard. Meanwhile, the input field F62 is a field for inputting symbol information indicating whether the lower limit value indicated by the filling time lower limit value information input to the input field F61 is included in the filling time range. In the input field F62, “≤” indicating that the lower limit value is included in the filling time range is input as an example of the symbol information. When the lower limit value is not included in the filling time range, “<” indicating that the lower limit value is not included in the filling time range is input to the input field F62. The symbol information may be input to the input field F62 by selecting information from a pull-down menu or may be directly input by an input device such as a keyboard.

The input field F7 includes two input fields, that is, an input field F71 and an input field F72. The input field F71 is a field for inputting the filling time upper limit value information. In the example shown in FIG. 7, in the input field F71, “15.0” indicating fifteen seconds is input as an example of the filling time upper limit value information. The filling time upper limit value information may be input to the input field F71 by selecting information from a pull-down menu, or may be directly input using an input device such as a keyboard. Meanwhile, the input field F72 is a field for inputting symbol information indicating whether the upper limit value indicated by the filling time upper limit value information input to the input field F71 is included in the filling time range. In the input field F72, “<” indicating that the upper limit value is not included in the filling time range is input as an example of the symbol information. When the upper limit value is included in the filling time range, “≤” indicating that the upper limit value is included in the filling time range is input to the input field F72. The symbol information may be input to the input field F72 by selecting information from a pull-down menu or may be directly input by an input device such as a keyboard.

The button B2 is a button for receiving an operation of displaying an input field for receiving, in addition to each piece of information input to each of the input field F4 to the input field F7, other information as the extraction condition. When a selection operation is performed on the button B2, the information processing device X displays an image for receiving an operation of designating other information desired to be added as the extraction condition and an operation of designating whether to add the added extraction condition as an AND search extraction condition or as an OR search extraction condition. Then, in response to an operation received via the displayed image, the information processing device X adds and displays an input field for receiving the added extraction condition on the extraction condition reception image P2. A method of adding and displaying the input field on the extraction condition reception image P2 may be a known method or a method to be developed in the future.

The button B3 is a button for receiving an operation of using each piece of information input to a part or all of the input field F4 to the input field F7 as the search key to search for the cycle data based on the search key. That is, when a selection operation on the button B3 is received, the information processing device X extracts, as a candidate of the first cycle data, one or more pieces of cycle data corresponding to the respective pieces of information input to a part or all of the input field F4 to the input field F7. Here, when the number of pieces of cycle data extracted as the cycle data whose position is to be fixed is one, the information processing device X specifies the extracted cycle data as the first cycle data. When the number of pieces of cycle data extracted as the cycle data whose position is to be fixed is two or more, the information processing device X causes the user to input the extraction condition again until the number of pieces of extracted cycle data is one. Accordingly, the user can specify the desired cycle data more quickly than by visual searching. A method of causing the user to input the extraction condition again may be a known method or a method to be developed in the future.

Here, the information processing device X may be configured to repeatedly display the extraction condition reception image P2 the same number of times as the number of pieces of desired cycle data whose positions are desired to be fixed by the user, and fix the positions of the cycle data of the same number of pieces as the number of times the extraction condition reception image P2 is displayed. In this case, for example, the information processing device X specifies the cycle data extracted via the extraction condition reception image P2 displayed for a first time as the first cycle data, and specifies the cycle data extracted via the extraction condition reception image P2 displayed for a second time as the second cycle data.

Further, the information processing device X may be configured to specify, in response to a received operation, each of two or more pieces of cycle data extracted via the extraction condition reception image P2 as the cycle data whose position is to be fixed. In this case, for example, the information processing device X specifies one of two pieces of cycle data extracted via the extraction condition reception image P2 as the first cycle data, and specifies the other of the two pieces of cycle data as the second cycle data. A method of specifying one of the two pieces of cycle data as the first cycle data and specifying the other of the two pieces of cycle data as the second cycle data may be a known method or a method to be developed in the future.

As described above, the information processing device X displays the search image P1 including the search result list in response to a received operation, and after the search result list is displayed, in response to the received first position fixing operation, fixes the position of the first cycle data designated by the first position fixing operation among the cycle data included in the search result list at the first fixed position designated by the first position fixing operation. Accordingly, the information processing device X can make it possible to efficiently compare the desired cycle data. Then, such processing executed by the information processing device X may be executed on the injection molding condition data instead of the cycle data. Such processing executed by the information processing device X may be executed on other data acquired by the information processing device X from the injection molding apparatus.

The information processing device X may be configured to, after the first cycle data is fixed at the first fixed position, execute processing to be described below for each piece of actual value information included in the first cycle data, for example. The information processing device X specifies each piece of cycle data other than the first cycle data among the cycle data included in the search result list as comparison target cycle data. The information processing device X specifies a cycle time indicated by the cycle time information included in the first cycle data as a reference value for the cycle time, and specifies a cycle time indicated by the cycle time information included in each piece of the comparison target cycle data as a comparison target value for the cycle time. After specifying the reference value and the comparison target value for the cycle time, the information processing device X displays, for each piece of comparison target cycle data, the comparison target value displayed in a record in which a corresponding piece of comparison target cycle data is shown, that is, the cycle time displayed in the record according to a predetermined display rule RL0. Here, the display rule RL0 is, for example, a rule of displaying the comparison target value in a color different from that of the reference value when the comparison target value is a value different from the reference value. In this case, the information processing device X can highlight the comparison target value having a value different from the reference value by color in the search result list. Accordingly, the information processing device X can make it possible to easily and visually specify whether the cycle time changes in the cycle data desired by the user. The information processing device X performs the above processing for each piece of actual value information included in the first cycle data. That is, the information processing device X can make it possible to easily and visually specify, for each actual value, whether the actual value changes in the cycle data desired by the user.

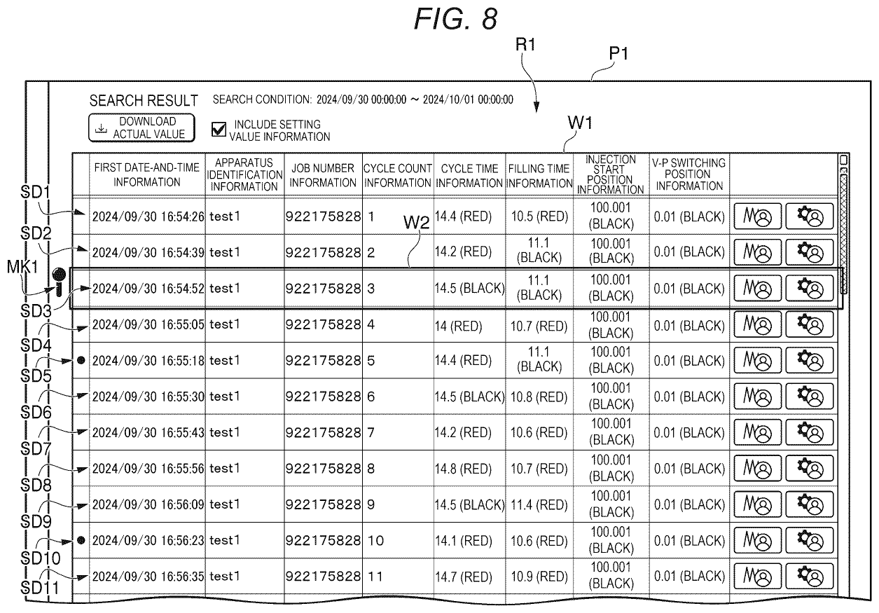

FIG. 8 is a diagram showing a first example of a state in which the comparison target values are displayed in the search result list according to the display rule RL0 after the first cycle data is fixed at the first fixed position. In FIG. 8, a search result list similar to the search result list shown in FIG. 3 is displayed in the search result display region R1. In the example shown in FIG. 8, as in the example shown in FIG. 3, the cycle data SD3 is fixed as the first cycle data at the first fixed position indicated by the frame W2. In this case, the information processing device X specifies an actual value indicated by each piece of actual value information included in the cycle data SD3, which is an example of the first cycle data, as the reference value for the actual value. In the example shown in FIG. 8, the information processing device X specifies, for example, “14.5” as the reference value for the cycle time. In this example, the information processing device X specifies, for example, “11.1” as the reference value for the filling time. Further, the information processing device X specifies each of 10 pieces of cycle data other than the cycle data SD3, which is an example of the first cycle data, among the cycle data SD1 to the cycle data SD11 as comparison target cycle data. The information processing device X specifies, for each piece of specified comparison target cycle data, an actual value indicated by each piece of actual value information included in a corresponding piece of comparison target cycle data as the comparison target value for the actual value. In this example, the information processing device X specifies, for the cycle data SD2, for example, “14.2” as the comparison target value for the cycle time. Further, in this example, the information processing device X specifies, for the cycle data SD2, for example, “11.1” as a comparison target value for the filling time. Here, “14.2” which is a cycle time indicated by the cycle time information in the cycle data SD2 is a value different from “14.5” which is a cycle time indicated by the cycle time information in the cycle data SD3. This means that the comparison target value for the cycle time in the cycle data SD2 is different from the reference value for the cycle time. In such a case, the information processing device X displays “14.2”, which is a cycle time included in a record in which the cycle data SD2 is shown, in a color different from a color of “14.5”, which is a cycle time included in a record in which the cycle data SD3 is shown. In this example, “14.2” is displayed in red. Meanwhile, in this example, “14.5” is displayed in black. Accordingly, the information processing device X can make it possible to easily and visually specify whether the cycle time changes in the cycle data desired by the user. “11.1” which is a filling time indicated by the filling time information in the cycle data SD2 has the same value as “11.1” which is a filling time indicated by the filling time information in the cycle data SD3. This means that the comparison target value for the cycle time in the cycle data SD2 has the same as the reference value for the cycle time. In such a case, the information processing device X displays “11.1” which is a filling time included in the record in which the cycle data SD2 is shown in the same color as “11.1” which is a filling time included in the record in which the cycle data SD3 is shown. In this example, “11.1” in the record in which the cycle data SD2 is shown is displayed in black. Meanwhile, in this example, “11.1” in the record in which the cycle data SD3 is shown is also displayed in black. Accordingly, the information processing device X can make it possible to easily and visually specify whether the cycle time changes in the cycle data desired by the user.

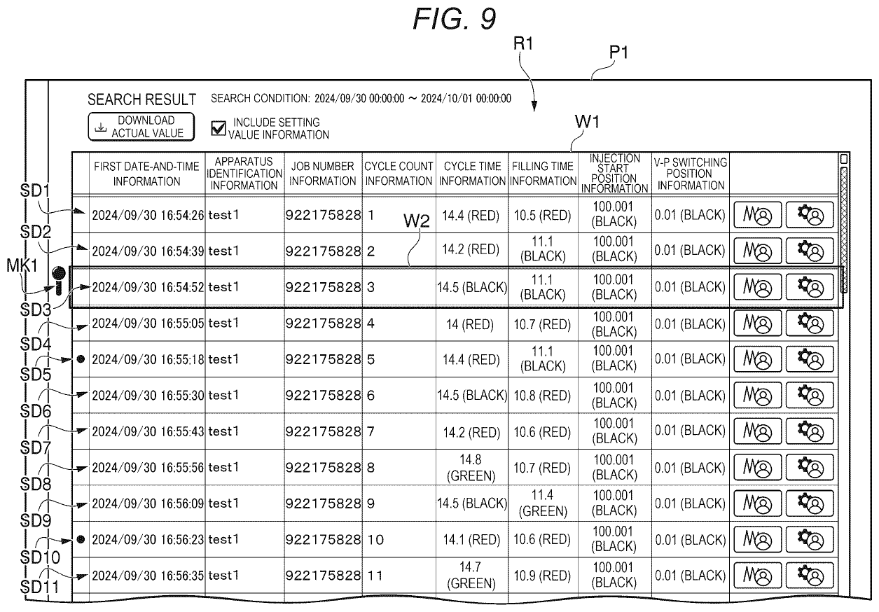

The information processing device X may be configured to change the color of the comparison target value between a case in which a value obtained by subtracting the reference value from the comparison target value is positive and a case in which the value obtained by subtracting the reference value from the comparison target value is negative. FIG. 9 is a diagram showing a second example of the state in which the comparison target values are displayed in the search result list according to the display rule RL0 after the first cycle data is fixed at the first fixed position. In FIG. 9, a search result list similar to the search result list shown in FIG. 3 is displayed in the search result display region R1. In the example shown in FIG. 9, as in the example shown in FIG. 3, the cycle data SD3 is fixed as the first cycle data at the first fixed position indicated by the frame W2. In this case, the information processing device X specifies the actual value indicated by each piece of actual value information included in the cycle data SD3, which is an example of the first cycle data, as the reference value for the actual value. In the example shown in FIG. 9, the information processing device X specifies, for example, “14.5” as the reference value for the cycle time. In this example, the information processing device X specifies, for example, “11.1” as the reference value for the filling time. Further, the information processing device X specifies each of 10 pieces of cycle data other than the cycle data SD3, which is an example of the first cycle data, among the cycle data SD1 to the cycle data SD11 as comparison target cycle data. The information processing device X specifies, for each piece of specified comparison target cycle data, an actual value indicated by each piece of actual value information included in a corresponding piece of comparison target cycle data as the comparison target value for the actual value. In this example, the information processing device X specifies, for the cycle data SD11, for example, “14.7” as the comparison target value for the cycle time. Further, in this example, the information processing device X specifies, for the cycle data SD11, for example, “10.9” as the comparison target value for the filling time. Here, “14.7” which is a cycle time indicated by the cycle time information in the cycle data SD11 is a value different from “14.5” which is a cycle time indicated by the cycle time information in the cycle data SD3, and is a value larger than “14.5”. This means that a value obtained by subtracting the reference value for the cycle time from the comparison target value for the cycle time in the cycle data SD11 is positive. In such a case, the information processing device X displays “14.7”, which is a cycle time included in a record in which the cycle data SD11 is shown, in a color different from a color of “14.5”, which is a cycle time included in a record in which the cycle data SD3 is shown. In this example, “14.7” is displayed in green. Meanwhile, in this example, “14.5” is displayed in black. Accordingly, the information processing device X can make it possible to easily and visually specify whether the cycle time increases in the cycle data desired by the user. Further, “10.9” which is a filling time indicated by the filling time information in the cycle data SD11 is a value different from “11.1” which is a filling time indicated by the filling time information in the cycle data SD3, and is a value smaller than “11.1”. This means that a value obtained by subtracting the reference value for the cycle time from the comparison target value for the cycle time in the cycle data SD11 is negative. In such a case, the information processing device X displays “10.9” which is a filling time included in the record in which the cycle data SD11 is shown in a color different from a color of “11.1” which is a filling time included in the record in which the cycle data SD3 is shown. In this example, “10.9” in the record in which the cycle data SD11 is shown is displayed in red. Meanwhile, in this example, “11.1” in the record in which the cycle data SD3 is shown is displayed in black. Accordingly, the information processing device X can make it possible to easily and visually specify whether the cycle time decreases in the cycle data desired by the user.

Instead of the rule described above, the display rule RL0 may be a rule for displaying an image indicating that the comparison target value is different from the reference value in association with the comparison target value, when the comparison target value is different from the reference value. Further, the image indicating that the comparison target value is different from the reference value has a different design depending on whether the value obtained by subtracting the reference value from the comparison target value is a positive value. Accordingly, the information processing device X can make it possible to easily and visually specify whether each actual value changes in the cycle data desired by the user.

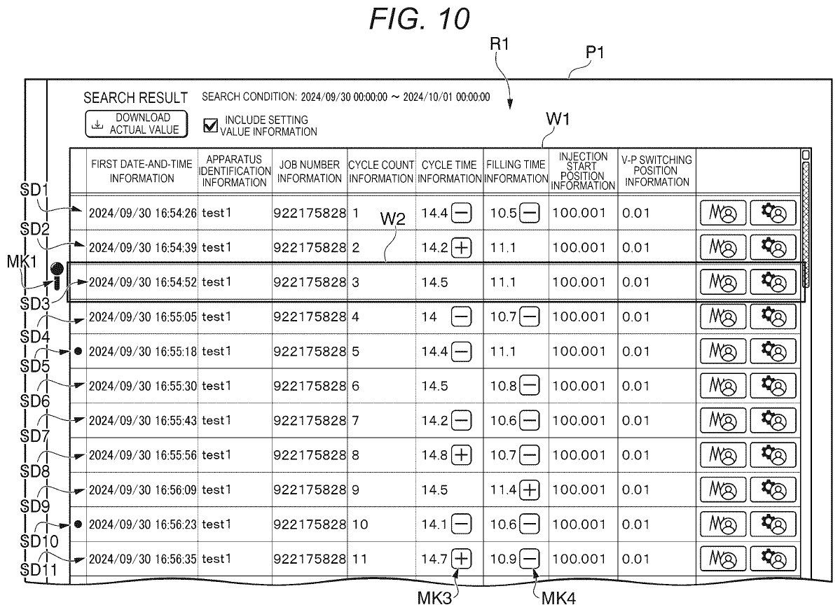

FIG. 10 is a diagram showing a third example of the state in which the comparison target values are displayed in the search result list according to the display rule RL0 after the first cycle data is fixed at the first fixed position. In FIG. 10, a search result list similar to the search result list shown in FIG. 3 is displayed in the search result display region R1. In the example shown in FIG. 10, as in the example shown in FIG. 3, the cycle data SD3 is fixed as the first cycle data at the first fixed position indicated by the frame W2. In this case, the information processing device X specifies the actual value indicated by each piece of actual value information included in the cycle data SD3, which is an example of the first cycle data, as the reference value for the actual value. In this example, the information processing device X specifies, for example, “14.5” as the reference value for the cycle time. In this example, the information processing device X specifies, for example, “11.1” as the reference value for the filling time. Further, the information processing device X specifies each of 10 pieces of cycle data other than the cycle data SD3, which is an example of the first cycle data, among the cycle data SD1 to the cycle data SD11 as comparison target cycle data. The information processing device X specifies, for each piece of specified comparison target cycle data, an actual value indicated by each piece of actual value information included in a corresponding piece of comparison target cycle data as the comparison target value for the actual value. In this example, the information processing device X specifies, for the cycle data SD11, for example, “14.7” as the comparison target value for the cycle time. Further, in this example, the information processing device X specifies, for the cycle data SD11, for example, “10.9” as the comparison target value for the filling time.

Here, “14.7” which is a cycle time indicated by the cycle time information in the cycle data SD11 is a value different from “14.5” which is a cycle time indicated by the cycle time information in the cycle data SD3, and is a value larger than “14.5”. This means that a value obtained by subtracting the reference value for the cycle time from the comparison target value for the cycle time in the cycle data SD11 is positive. In such a case, the information processing device X displays an image indicating that the comparison target value is larger than the reference value in association with the comparison target value. Each of an image MK3 shown in FIG. 10 and an image having the same design as the image MK3 in FIG. 10 is an example of the image indicating that the comparison target value is larger than the reference value. Accordingly, the information processing device X can make it possible to easily and visually specify whether the cycle time increases in the cycle data desired by the user. Further, “10.9” which is a filling time indicated by the filling time information in the cycle data SD11 is a value different from “11.1” which is a filling time indicated by the filling time information in the cycle data SD3, and is a value smaller than “11.1”. This means that a value obtained by subtracting the reference value for the filling time from the comparison target value for the filling time in the cycle data SD11 is negative. In such a case, the information processing device X displays an image indicating that the comparison target value is smaller than the reference value in association with the comparison target value. Each of an image MK4 shown in FIG. 10 and an image having the same design as the image MK4 in FIG. 10 is an example of the image indicating that the comparison target value is smaller than the reference value. Accordingly, the information processing device X can make it possible to easily and visually specify whether the filling time decreases in the cycle data desired by the user. A design of each of the image MK3 and the image MK4 may be another design instead of the design shown in FIG. 10. The image MK3 and the image MK4 may have the same design. In this case, the information processing device X can make it possible to easily and visually specify whether the cycle time increases in the cycle data desired by the user.

The image indicating that the comparison target value is different from the reference value may have a different design depending on a difference between the comparison target value and the reference value. In this case, in the search result list, the information processing device X can highlight the comparison target value, which is a value different from the reference value, by the image, and can represent a degree of difference between the comparison target value and the reference value by the image. Accordingly, the information processing device X can make it possible to easily and visually specify whether each actual value changes in the cycle data desired by the user and a degree of the change.

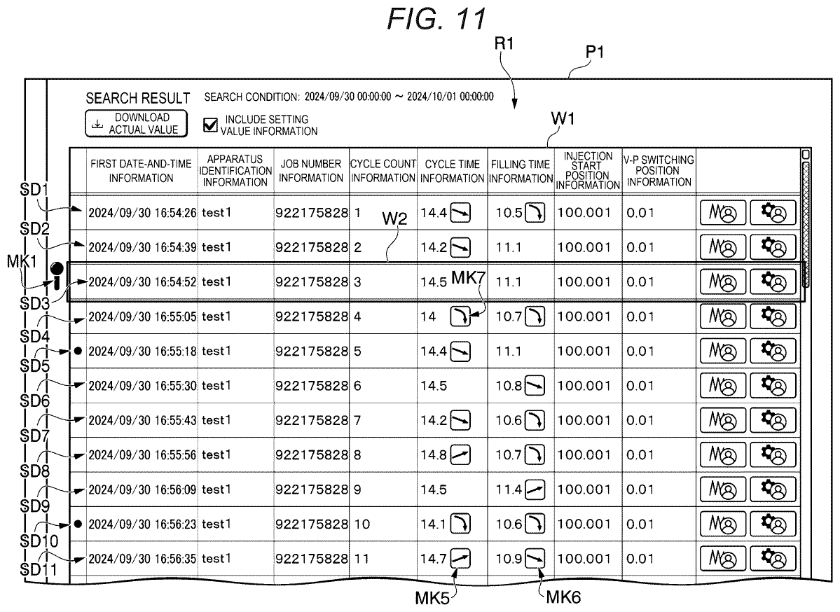

FIG. 11 is a diagram showing a fourth example of the state in which the comparison target values are displayed in the search result list according to the display rule RL0 after the first cycle data is fixed at the first fixed position. In FIG. 11, a search result list similar to the search result list shown in FIG. 3 is displayed in the search result display region R1. In the example shown in FIG. 11, as in the example shown in FIG. 3, the cycle data SD3 is fixed as the first cycle data at the first fixed position indicated by the frame W2. In this case, the information processing device X specifies the actual value indicated by each piece of actual value information included in the cycle data SD3, which is an example of the first cycle data, as the reference value for the actual value. In this example, the information processing device X specifies, for example, “14.5” as the reference value for the cycle time. In this example, the information processing device X specifies, for example, “11.1” as the reference value for the filling time. Further, the information processing device X specifies each of 10 pieces of cycle data other than the cycle data SD3, which is an example of the first cycle data, among the cycle data SD1 to the cycle data SD11 as comparison target cycle data. The information processing device X specifies, for each piece of specified comparison target cycle data, an actual value indicated by each piece of actual value information included in a corresponding piece of comparison target cycle data as the comparison target value for the actual value. In this example, the information processing device X specifies, for the cycle data SD11, for example, “14.7” as the comparison target value for the cycle time. Further, in this example, the information processing device X specifies, for the cycle data SD11, for example, “10.9” as the comparison target value for the filling time. In this example, the information processing device X specifies, for the cycle data SD4, for example, “14” as the comparison target value for the cycle time. Further, in this example, the information processing device X specifies, for the cycle data SD4, for example, “10.7” as the comparison target value for the filling time.

Here, “14.7” which is a cycle time indicated by the cycle time information in the cycle data SD11 is a value different from “14.5” which is a cycle time indicated by the cycle time information in the cycle data SD3, and is a value larger than “14.5”. This means that a value obtained by subtracting the reference value for the cycle time from the comparison target value for the cycle time in the cycle data SD11 is positive. In such a case, the information processing device X determines whether the difference between the comparison target value and the reference value is equal to or greater than a first threshold for the cycle time. The first threshold is, for example, 0.4, but may be a value smaller than 0.4 or a value larger than 0.4. When it is determined that the difference is less than the first threshold, the information processing device X determines that a tendency of the change in the comparison target value relative to the reference value is a gentle increase, and displays an image indicating that the tendency of the change in the comparison target value relative to the reference value is a gentle increase, in association with the comparison target value. On the other hand, when it is determined that the difference is equal to or greater than the first threshold, the information processing device X determines that the tendency of the change in the comparison target value relative to the reference value is a rapid increase, and displays an image indicating that the tendency of the change in the comparison target value relative to the reference value is a rapid increase, in association with the comparison target value. In the example shown in FIG. 11, the change in the comparison target value relative to the reference value is less than the first threshold. Therefore, an image indicating that the tendency of the change in the comparison target value relative to the reference value is a gentle increase is displayed in association with “14.7” which is the comparison target value. Each of an image MK5 shown in FIG. 11 and an image having the same design as the image MK5 in FIG. 11 is an example of the image indicating that the tendency of the change in the comparison target value relative to the reference value is a gentle increase. By displaying the image indicating the tendency of the change in the comparison target value relative to the reference value in this way, the information processing device X can make it possible to easily and visually specify that the cycle time increases in the cycle data desired by the user, and can also make it possible to easily and visually specify a tendency of the change in the cycle time.

Further, “10.9” which is a filling time indicated by the filling time information in the cycle data SD11 is a value different from “11.1” which is a filling time indicated by the filling time information in the cycle data SD3, and is a value smaller than “11.1”. This means that a value obtained by subtracting the reference value for the filling time from the comparison target value for the cycle time in the cycle data SD11 is negative. In such a case, the information processing device X determines whether a difference between “10.9” and “11.1” is equal to or smaller than a second threshold for the filling time. The second threshold is, for example, 0.4, but may be a value smaller than 0.4 or a value larger than 0.4. When it is determined that the difference is less than the second threshold, the information processing device X determines that a tendency of the change in the comparison target value relative to the reference value is a gentle decrease, and displays an image indicating that the tendency of the change in the comparison target value relative to the reference value is a gentle decrease, in association with the comparison target value. On the other hand, when it is determined that the difference is equal to or greater than the second threshold, the information processing device X determines that the tendency of the change in the comparison target value relative to the reference value is a rapid decrease, and displays an image indicating that the tendency of the change in the comparison target value relative to the reference value is a rapid decrease, in association with the comparison target value. In the example shown in FIG. 11, the change in the comparison target value relative to the reference value is smaller than the second threshold. Therefore, an image indicating that the tendency of the change in the comparison target value relative to the reference value is a gentle decrease is displayed in association with “10.9” which is the comparison target value. Each of an image MK6 shown in FIG. 11 and an image having the same design as the image MK6 in FIG. 11 is an example of the image indicating that the tendency of the change in the comparison target value relative to the reference value is a gentle decrease. By displaying the image indicating the tendency of the change in the comparison target value relative to the reference value in this way, the information processing device X can make it possible to easily and visually specify that the filling time decreases in the cycle data desired by the user, and can also make it possible to easily and visually specify a tendency of a change in the filling time.

Further, “14” which is a cycle time indicated by the cycle time information in the cycle data SD4 is a value different from “14.5” which is a cycle time indicated by the cycle time information in the cycle data SD3, and is a value smaller than “14.5”. This means that a value obtained by subtracting the reference value for the cycle time from the comparison target value for the cycle time in the cycle data SD4 is negative. In such a case, the information processing device X determines whether a difference between “14” and “14.5” is equal to or smaller than a second threshold for the cycle time. The second threshold is, for example, 0.4, but may be a value smaller than 0.4 or a value larger than 0.4. When it is determined that the difference is less than the second threshold, the information processing device X determines that a tendency of the change in the comparison target value relative to the reference value is a gentle decrease, and displays an image indicating that the tendency of the change in the comparison target value relative to the reference value is a gentle decrease, in association with the comparison target value. On the other hand, when it is determined that the difference is equal to or greater than the second threshold, the information processing device X determines that the tendency of the change in the comparison target value relative to the reference value is a rapid decrease, and displays an image indicating that the tendency of the change in the comparison target value relative to the reference value is a rapid decrease, in association with the comparison target value. In the example shown in FIG. 11, the change in the comparison target value relative to the reference value is greater than the second threshold. Therefore, an image indicating that the tendency of the change in the comparison target value relative to the reference value is a rapid decrease is displayed in association with “14” which is the comparison target value. Each of an image MK7 shown in FIG. 11 and an image having the same design as the image MK7 in FIG. 11 is an example of the image indicating that the tendency of the change in the comparison target value relative to the reference value is a rapid decrease. By displaying the image indicating the tendency of the change in the comparison target value relative to the reference value in this way, the information processing device X can make it possible to easily and visually specify that the cycle time decreases in the cycle data desired by the user, and can also make it possible to easily and visually specify the tendency of the change in the cycle time. In the example shown in FIG. 11, an image indicating a rapid increase is not displayed in the search result list.

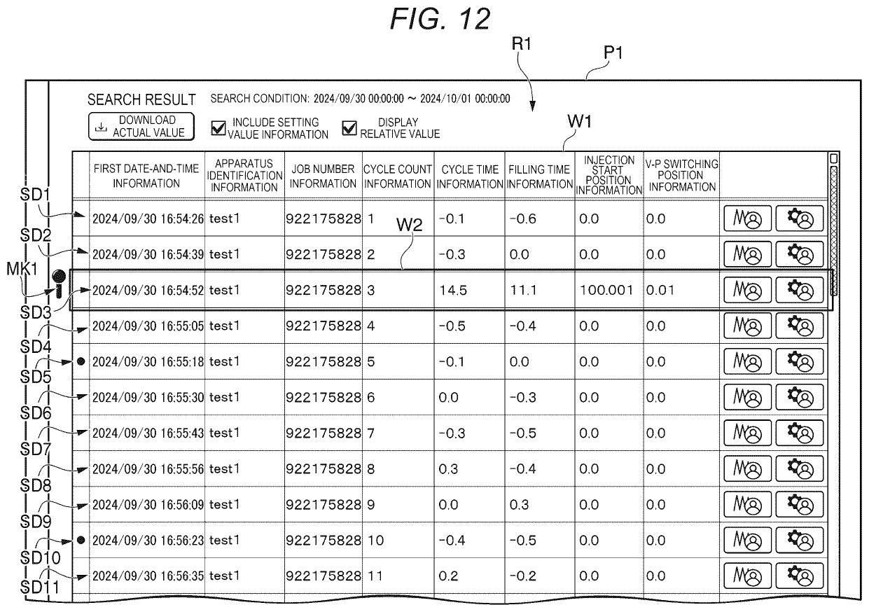

The display rule RL0 may be, for example, a rule of displaying the comparison target value by the difference with the reference value, instead of the rule described above. In this case, the information processing device X can make it possible to visually display a degree of change in the comparison target value relative to the reference value in the search result list. As a result, the information processing device X can make it possible to easily and visually specify a degree of change in each actual value in the cycle data desired by the user. FIG. 12 is a diagram showing a fifth example of the state in which the comparison target values are displayed in the search result list according to the display rule RL0 after the first cycle data is fixed at the first fixed position. In FIG. 12, a search result list similar to the search result list shown in FIG. 3 is displayed in the search result display region R1. In the example shown in FIG. 12, as in the example shown in FIG. 3, the cycle data SD3 is fixed as the first cycle data at the first fixed position indicated by the frame W2. In this case, the information processing device X specifies the actual value indicated by each piece of actual value information included in the cycle data SD3, which is an example of the first cycle data, as the reference value for the actual value. In the example shown in FIG. 12, the information processing device X specifies, for example, “14.5” as the reference value for the cycle time. In this example, the information processing device X specifies, for example, “11.1” as the reference value for the filling time. Further, the information processing device X specifies each of 10 pieces of cycle data other than the cycle data SD3, which is an example of the first cycle data, among the cycle data SD1 to the cycle data SD11 as comparison target cycle data. The information processing device X specifies, for each piece of specified comparison target cycle data, an actual value indicated by each piece of actual value information included in a corresponding piece of comparison target cycle data as the comparison target value for the actual value. Then, the information processing device X displays each specified comparison target value as a difference with the reference value for a corresponding comparison target value. In this example, the information processing device X displays, for example, “−0.3” as a cycle time indicated by the cycle time information included in the record in which the cycle data SD2 is shown. This indicates that a difference between the reference value for the cycle time and the cycle time indicated by the cycle time information is −0.3. In this example, the information processing device X displays, for example, “0.0” as a filling time indicated by the filling time information included in the record in which the cycle data SD2 is shown. This indicates that a difference between the reference value for the filling time and the filling time indicated by the filling time information is 0.0.

The display rule RL0 may be, for example, a rule of displaying the comparison target value by a ratio to the reference value, instead of the rule described above. In this case, the information processing device X can also make it possible to visually display a degree of change in the comparison target value relative to the reference value in the search result list. As a result, the information processing device X can make it possible to easily and visually specify the degree of change in each actual value in the cycle data desired by the user. An example of the search result list in this case is a search result list in a case in which the comparison target value in FIG. 12 is replaced from the difference to the ratio. Therefore, in the present embodiment, a description of the search result list in this case is omitted.

Further, the information processing device X may be configured to display the comparison target value according to a combination of the display rules RL0 described above in the search result list. For example, the information processing device X may be configured such that the display rule RL0 described in FIG. 8 is set as a display rule RL01, the display rule RL0 described in FIG. 12 is set as a display rule RL02, and the comparison target value is displayed according to a combination of the display rule RL01 and the display rule RL02 in the search result list.

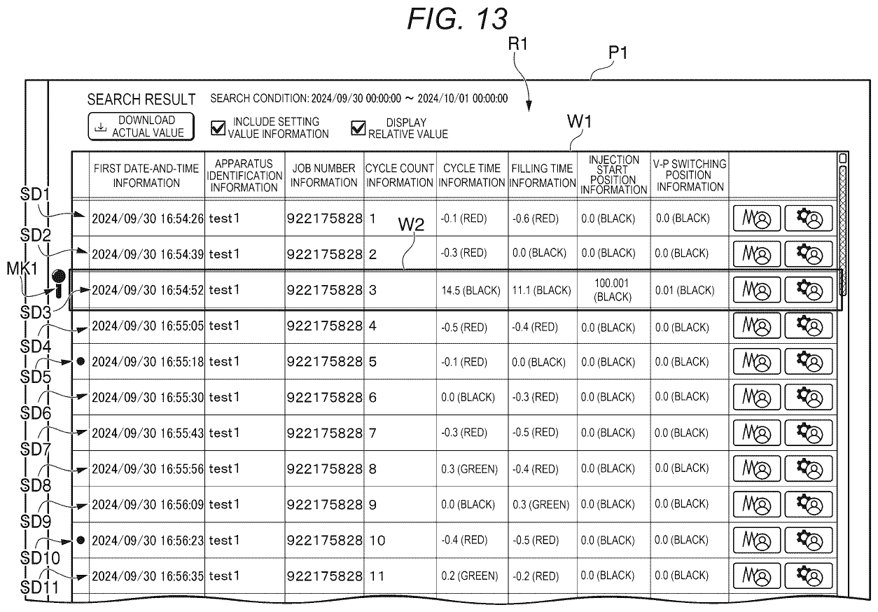

FIG. 13 is a diagram showing a first example of a state in which the comparison target values are displayed in the search result list according to a combination of a display rule RL01 and a display rule RL02 after the first cycle data is fixed at the first fixed position. In FIG. 13, a search result list similar to the search result list shown in FIG. 3 is displayed in the search result display region R1. In the example shown in FIG. 13, the cycle data selected as the first cycle data is also the cycle data SD3. As shown in FIG. 13, after the first cycle data is fixed at the first fixed position, when the comparison target value is a value different from the reference value, the information processing device X displays, in the search result list, the comparison target value in a color different from a color of the reference value and displays the comparison target value by the difference with the reference value. Accordingly, the information processing device X can make it possible to more reliably specify, for each actual value, whether the actual value changes in the cycle data desired by the user.

After the first cycle data is fixed at the first fixed position and the second cycle data is fixed at the second fixed position, the information processing device X may be configured to specify an actual value indicated by each piece of actual value information included in the first cycle data as a first reference value, specify an actual value indicated by each piece of actual value information included in the second cycle data as a second reference value, and perform display corresponding to the specified first reference value and second reference value in the search result list. For example, the information processing device X performs the display corresponding to the specified first reference value and second reference value in the search result list by the following processing. After the first cycle data is fixed at the first fixed position, the information processing device X specifies cycle data other than the first cycle data as first comparison target cycle data. After the second cycle data is fixed at the first fixed position, the information processing device X specifies cycle data other than the second cycle data as second comparison target cycle data. Here, the first comparison target cycle data includes the second cycle data. Further, the second comparison target cycle data includes the first cycle data. Then, the information processing device X specifies an actual value indicated by each piece of actual value information included in the first comparison target cycle data as a first comparison target value. Further, the information processing device X specifies an actual value indicated by each piece of actual value information included in the second comparison target cycle data as a second comparison target value. Then, the information processing device X displays each first comparison target value according to the predetermined first display rule RL1 corresponding to the first reference value, and displays each second comparison target value according to the predetermined second display rule RL2 corresponding to the second reference value. However, the first display rule RL1 and the second display rule RL2 are different rules. The information processing device X performs the display corresponding to the specified first reference value and second reference value in the search result list by the above processing.

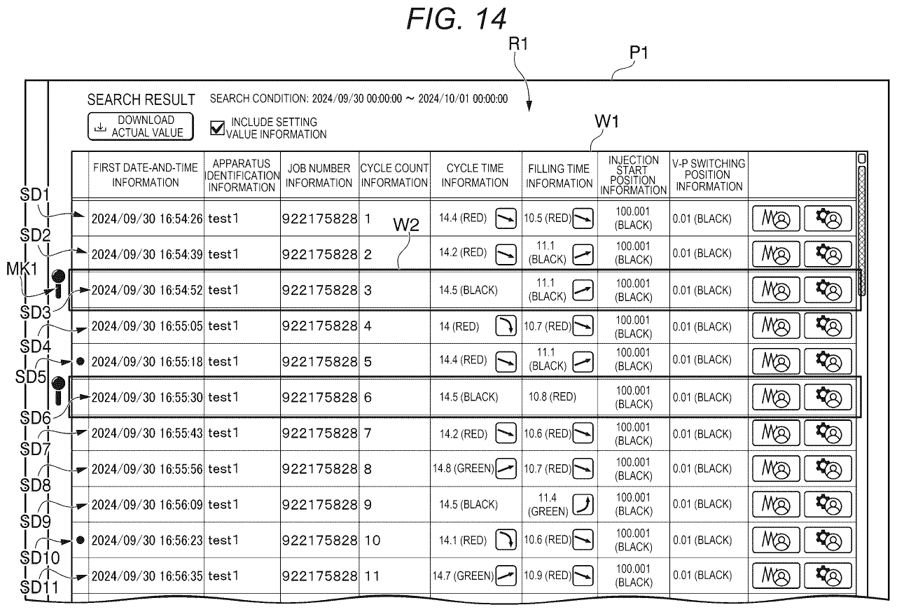

FIG. 14 is a diagram showing an example of a state in which the first comparison target values are displayed according to the first display rule RL1 and the second comparison target values are displayed according to the second display rule RL2 in the search result list after the first cycle data is fixed at the first fixed position and the second cycle data is fixed at the second fixed position. In FIG. 14, a search result list similar to the search result list shown in FIG. 3 is displayed in the search result display region R1. In the example shown in FIG. 14, the cycle data selected as the first cycle data is the cycle data SD3. In this example, the cycle data selected as the second cycle data is the cycle data SD6. Therefore, for example, the information processing device X specifies “14.5”, which is a cycle time included in the record in which the cycle data SD3 is shown, as a first reference value for the cycle time. For example, the information processing device X specifies “11.1”, which is a filling time included in the record, as a first reference value for the filling time. Further, the information processing device X specifies each of 10 pieces of cycle data other than the cycle data SD3, which is an example of the first cycle data, among the cycle data SD1 to the cycle data SD11 as the first comparison target cycle data. Then, the information processing device X specifies an actual value indicated by each piece of actual value information included in the first comparison target cycle data as the first comparison target value. A method of specifying the first comparison target value is similar to the method of specifying the comparison target value. Meanwhile, for example, the information processing device X specifies “14.5”, which is a cycle time included in the record in which the cycle data SD6 is shown, as a second reference value for the cycle time. For example, the information processing device X specifies “10.8”, which is a filling time included in the record, as a second reference value for the filling time. Further, the information processing device X specifies each of 10 pieces of cycle data other than the cycle data SD6, which is an example of the second cycle data, among the cycle data SD1 to the cycle data SD11 as the second comparison target cycle data. Then, the information processing device X specifies an actual value indicated by each piece of actual value information included in the second comparison target cycle data as the second comparison target value. A method of specifying the second comparison target value is similar to the method of specifying the comparison target value.

The information processing device X displays each first comparison target value according to the predetermined first display rule RL1 corresponding to the first reference value. In the example shown in FIG. 14, the first display rule RL1 is the display rule RL0 described in FIG. 8. Therefore, in this example, the information processing device X displays, for example, a cycle time included in the record in which the cycle data SD2 which is an example of the first comparison target cycle data is shown, in red. In this example, the information processing device X displays, for example, the cycle time included in the record in which the cycle data SD6 which is an example of the first comparison target cycle data is shown, in black. In this example, the information processing device X displays, for example, a cycle time included in a record in which the cycle data SD8 which is an example of the first comparison target cycle data is shown, in green.

Meanwhile, the information processing device X displays each second comparison target value according to the predetermined second display rule RL2 corresponding to the second reference value. In the example shown in FIG. 14, the second display rule RL2 is the display rule RL0 described in FIG. 11. Therefore, in this example, for example, the information processing device X sets a filling time included in the record, in which the cycle data SD2 which is an example of the second comparison target cycle data is shown, as the second comparison target value, and displays an image indicating that a tendency of a change in the second comparison target value relative to the second reference value for the filling time is a gentle increase, in association with the second comparison target value. Further, in this example, for example, the information processing device X sets a filling time included in the record, in which the cycle data SD3 which is an example of the second comparison target cycle data is shown, as the second comparison target value, and displays an image indicating that a tendency of a change in the second comparison target value relative to the second reference value for the filling time is a gentle increase, in association with the second comparison target value. Further, in this example, for example, the information processing device X sets a filling time included in a record, in which the cycle data SD9 which is an example of the second comparison target cycle data is shown, as the second comparison target value, and displays an image indicating that a tendency of a change in the second comparison target value relative to the second reference value for the filling time is a rapid increase, in association with the second comparison target value. Accordingly, the information processing device X can make it possible to use the actual values included in two or more pieces of cycle data desired by the user as reference values, to visually compare tendencies of changes in the actual values included in other pieces of cycle data at the same time. This leads to an improvement in efficiency of cycle management by the user and is useful. For example, this can be used to specify a problem that cannot be found only by a simple difference when comparing a plurality of pieces of cycle data, and is useful. The first display rule RL1 may be a display rule RL0 other than the display rule RL0 described in FIG. 8, as long as being a display rule different from the second display rule RL2. The second display rule RL2 may be a display rule RL0 other than the display rule RL0 described in FIG. 11, as long as being a display rule different from the first display rule RL1.

Further, the information processing device X may be configured to perform display corresponding to the first reference value and the second reference value as described below, for example, instead of the display corresponding to the first reference value and the second reference value described in FIG. 14. The information processing device X specifies the actual value indicated by each piece of actual value information included in the first cycle data as the first reference value after the first cycle data is fixed at the first fixed position, and specifies the actual value indicated by each piece of actual value information included in the second cycle data as the second reference value after the second cycle data is fixed at the second fixed position. After specifying the first reference value and the second reference value, the information processing device X specifies a range in which a larger reference value of the first reference value and the second reference value is set as an upper limit value, and a smaller reference value of the first reference value and the second reference value is set as a lower limit value. Further, the information processing device X specifies one or more pieces of cycle data excluding the first cycle data and the second cycle data among the cycle data included in the search result list as comparison target cycle data, and specifies the actual value indicated by each piece of actual value information included in the comparison target cycle data as the comparison target value. The information processing device X displays the specified comparison target values according to a predetermined third display rule RL3 corresponding to the first reference value and the second reference value. Here, the third display rule RL3 is, for example, a rule of displaying the comparison target value in a color different from the colors of the first reference value and the second reference value when the comparison target value is a value outside the specified range. The third display rule RL3 may be another rule corresponding to the first reference value and the second reference value. By the processing as described above, the information processing device X performs the display according to the first reference value and the second reference value.

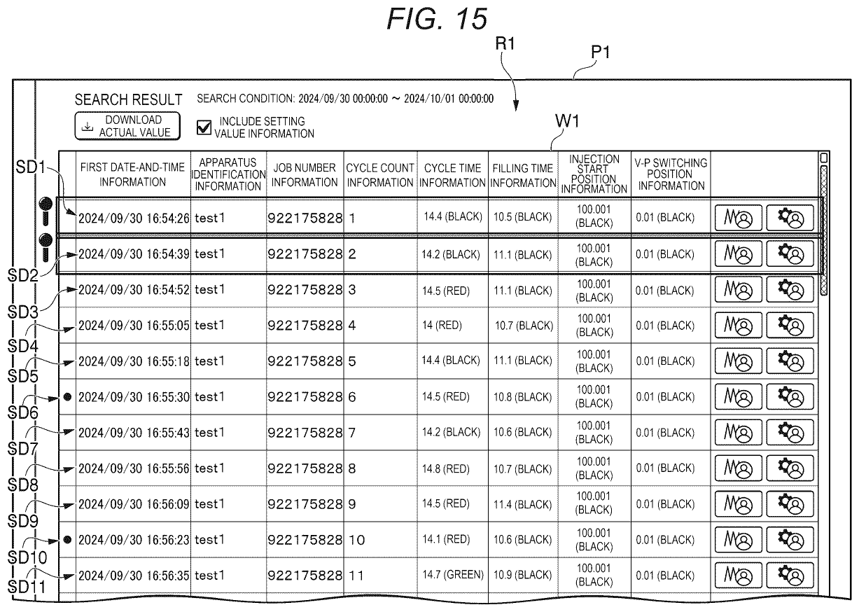

FIG. 15 is a diagram showing an example of a state in which the comparison target values are displayed in the search result list according to the third display rule RL3 after the first cycle data is fixed at the first fixed position and the second cycle data is fixed at the second fixed position. In FIG. 15, a search result list similar to the search result list shown in FIG. 3 is displayed in the search result display region R1. In the example shown in FIG. 15, the cycle data selected as the first cycle data is the cycle data SD1. In this example, the cycle data selected as the second cycle data is the cycle data SD2. Therefore, for example, the information processing device X specifies “14.4”, which is a cycle time included in a record in which the cycle data SD1 is shown, as the first reference value for the cycle time. For example, the information processing device X specifies “10.5”, which is a filling time included in the record, as the first reference value for the filling time. For example, the information processing device X specifies “14.2”, which is a cycle time included in the record in which the cycle data SD2 is shown, as the second reference value for the cycle time. For example, the information processing device X specifies “11.1”, which is a filling time included in the record, as the second reference value for the filling time. Then, for example, the information processing device X specifies, as a range for the cycle time, a range in which a larger reference value of the first reference value for the cycle time and the second reference value for the cycle time is set as an upper limit value and a smaller reference value of the first reference value and the second reference value is set as a lower limit value. Further, for example, the information processing device X specifies, as a range for the filling time, a range in which a larger reference value of the first reference value for the filling time and the second reference value for the filling time is set as an upper limit value and a smaller reference value of the first reference value and the second reference value is set as a lower limit value. Meanwhile, the information processing device X specifies each of nine cycle data other than the cycle data SD1 and the cycle data SD2 among the cycle data SD1 to the cycle data SD11 as the comparison target cycle data. Then, the information processing device X specifies an actual value indicated by each piece of actual value information included in the comparison target cycle data as the comparison target value. Therefore, for example, when a cycle time included in a record in which the comparison target cycle data is shown is set as the comparison target value and the comparison target value is a value outside the range for the cycle time, the information processing device X displays the comparison target value in a color different from a color of the first reference value for the cycle time and a color of the second reference value for the cycle time. In the example shown in FIG. 15, the color of each of the first reference value and the second reference value is black. In this example, for example, a color of a cycle time included in the record, in which the cycle data SD3 which is an example of the comparison target cycle data is shown, is red. Further, for example, when a filling time included in a record in which the comparison target cycle data is shown is set as the comparison target value and the comparison target value is a value outside the range of the filling time, the information processing device X displays the comparison target value in a color different from a color of the first reference value for the filling time and a color of the second reference value for the filling time. In the example shown in FIG. 15, the color of each of the first reference value and the second reference value is black. In this example, for example, a color of a filling time included in a record, in which the cycle data SD5 which is an example of the comparison target cycle data is shown, is also black. This is because the filling time is a value outside the range. Accordingly, the information processing device X can make it possible to specify a range corresponding to the actual values included in two pieces of cycle data desired by the user, and to visually specify whether each of the actual values included in other pieces of cycle data is included in the range. This also leads to the improvement in the efficiency of cycle management by the user, and is useful. For example, this can also be used to specify a problem that cannot be found only by the simple difference when comparing a plurality of pieces of cycle data, and is useful.

### Hardware Configuration of Information Processing Device X

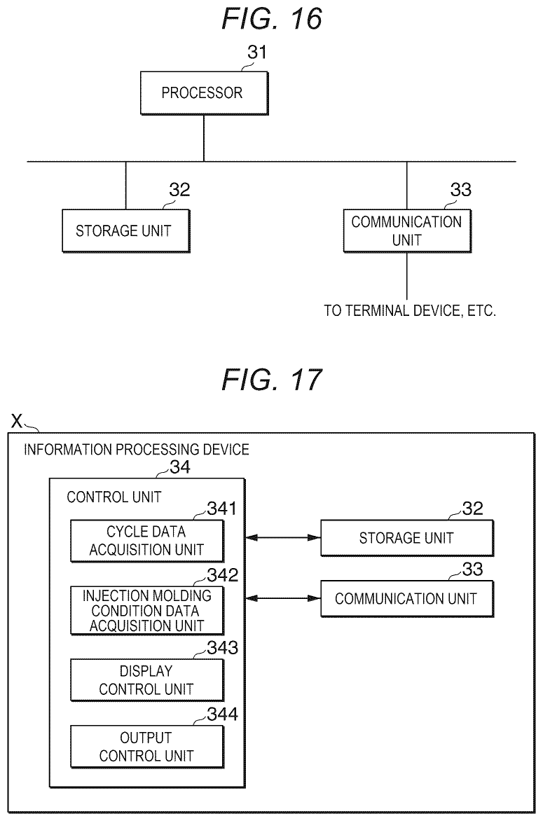

Here, the information processing device 20 and the server 30 may have the same hardware configuration or may have different hardware configurations. Hereinafter, as an example, a case in which the information processing device 20 and the server 30 have the same hardware configuration will be described. In other words, in one example, the information processing device X has a hardware configuration as shown in FIG. 16. FIG. 16 is a diagram showing an example of the hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a universal serial bus (USB). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### Functional Configuration of Information Processing Device X

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 17. FIG. 17 is a diagram showing an example of the functional configuration of the information processing device X.

The information processing device X includes the storage unit 32, the communication unit 33, and a control unit 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires the injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the search image P1 and the like. The display control unit 343 transmits the generated images to the terminal device 40 and displays the images on the terminal device 40.

The output control unit 344 outputs various types of data to another device in response to the received operation.

### Processing Performed by Information Processing Device X in Response to Received Operation

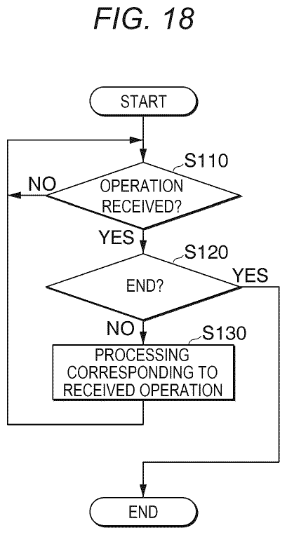

Referring to FIG. 18, processing performed by the information processing device X in response to each operation described above will be described. FIG. 18 is a diagram showing an example of a flow of the processing performed by the information processing device X in response to a received operation. Hereinafter, as an example, a case will be described in which the information processing device X is in a state in which various operations from the user can be received via the terminal device 40 at a timing before processing in step S110 shown in FIG. 18 is performed. Hereinafter, as an example, a case in which a plurality of pieces of cycle data and a plurality of pieces of injection molding condition data are already stored in the information processing device X at the timing will be described.

The control unit 34 waits until an operation is received via the terminal device 40 (step S110). In FIG. 18, the processing in step S110 is indicated by “operation received?”.

When it is determined that the operation has been received via the terminal device 40 (step S110: YES), the control unit 34 determines whether the received operation is an operation for ending the processing in the flowchart shown in FIG. 18 (step S120). The determination processing may be performed by the control unit 34 in step S120 by a known method or by a method to be developed in the future. In FIG. 18, the processing in step S120 is indicated by “end?”.

When it is determined that the operation received in step S110 is an operation for ending the processing in the flowchart shown in FIG. 18 (step S120: YES), the control unit 34 ends the processing in the flowchart shown in FIG. 18.

On the other hand, when it is determined that the operation received in step S110 is not an operation for ending the processing in the flowchart shown in FIG. 18 (step S120: NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIGS. 2 to 15, a detailed description of the processing will be omitted.

After the processing in step S130 is performed, the control unit 34 transitions to step S110 and waits again until an operation is received via the terminal device 40.

By the above processing, the information processing device X displays a list of the cycle data as the search result list in response to a received operation, and after the search result list is displayed, in response to the received first position fixing operation, fixes the position of the first cycle data designated by the first position fixing operation among the cycle data included in the search result list at the first fixed position designated by the first position fixing operation. Accordingly, the information processing device X can make it possible to efficiently compare the desired cycle data.

The molding management system 1 described above may include the terminal device 40. The molding management system 1 described above may include an injection molding apparatus such as the injection molding apparatus 11.

The contents described above may be combined in any manner.

### Appendix

[1]

A molding management system for managing production of a product in a production process including an injection molding process of the product performed by an injection molding apparatus, the molding management system including:
an information processing device communicably connected to a terminal device, in which
the information processing device
   acquires data including a plurality of types of information related to injection molding from the injection molding apparatus,
   displays a list of the data on a display unit in response to a first operation that is received, and
   fixes, in response to a second operation that is received, a position of first data designated by the second operation among the data included in the list at a first fixed position designated by the second operation, after the list is displayed on the display unit.
      [2]

The molding management system according to [1], in which
the first fixed position is a position of the first data in the list at a time point when the second operation is received.
   [3]

The molding management system according to [2], in which
a relative position of the first fixed position relative to a frame of the list does not change even when the data is scrolled in the list.
   [4]

The molding management system according to [3], in which
after fixing the first data at the first fixed position, the information processing device changes the first fixed position in the list in response to a third operation that is received.
   [5]

The molding management system according to any one of [1] to [4], in which
the first fixed position is a position outside the list.
   [6]

The molding management system according to any one of [1] to [5], in which
after the list is displayed, the information processing device displays, in response to a received operation, an extraction condition reception image for receiving an extraction condition for extracting the first data from the data, receives, as the second operation, an operation of receiving the extraction condition via the displayed extraction condition reception image, and specifies, as the first data, the data extracted according to the extraction condition received by the second operation.
   [7]

The molding management system according to any one of [1] to [6], in which
the information processing device acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus.
   [8]

The molding management system according to any one of [1] to [7], in which
after fixing the first data at the first fixed position, the information processing device specifies the first actual value indicated by the first actual value information included in the first data as a first reference value, specifies one or more pieces of data excluding the first data among the data included in the list as comparison target data, specifies the first actual value indicated by the first actual value information included in each piece of the comparison target data as a comparison target value, and displays, for each of the one or more pieces of comparison target data, the comparison target value in a corresponding piece of comparison target data according to a predetermined display rule.
   [9]

The molding management system according to [8], in which
the display rule is a rule of displaying the comparison target value in a color different from a color of the first reference value when the comparison target value is a value different from the first reference value.
   [10]

The molding management system according to [8], in which
the display rule is a rule of displaying, when the comparison target value is a value different from the first reference value, an image indicating that the comparison target value is different from the first reference value, in association with the comparison target value.
   [11]

The molding management system according to [10], in which
the image varies in design depending on a difference between the comparison target value and the first reference value.
   [12]

The molding management system according to [8], in which
the display rule is a rule of displaying the comparison target value by a difference with the first reference value.
   [13]

The molding management system according to [8], in which
the display rule is a rule of displaying the comparison target value by a ratio to the first reference value.
   [14]

The molding management system according to any one of [1] to [13], in which
after fixing the first data at the first fixed position, the information processing device fixes, in response to a fourth operation that is received, a position of second data designated by the fourth operation among the data included in the list at a second fixed position designated by the second operation,
the second data is that in the data, which is different from the first data, and
the second fixed position is a position different from the first fixed position.
   [15]

The molding management system according to any one of [1] to [13], in which
the information processing device
   acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus, and
   specifies the first actual value indicated by the first actual value information included in the first data as a first reference value after fixing the first data at the first fixed position, specifies the first actual value indicated by the first actual value information included in the second data as a second reference value after fixing the second data at the second fixed position, specifies one or more pieces of data excluding the first data among the data included in the list as first comparison target data, specifies one or more pieces of data excluding the second data among the data included in the list as second comparison target data, specifies the first actual value indicated by the first actual value information included in each piece of the first comparison target data as a first comparison target value, specifies the first actual value indicated by the first actual value information included in each piece of the second comparison target data as a second comparison target value, displays, for each of the one or more pieces of first comparison target data, the first comparison target value in a corresponding piece of the first comparison target data according to a predetermined first display rule corresponding to the first reference value, and displays, for each of the one or more pieces of second comparison target data, the second comparison target value in a corresponding piece of the second comparison target data according to a predetermined second display rule corresponding to the second reference value, and
the second display rule is a rule different from the first display rule.
   [16]

The molding management system according to any one of [1] to [13], in which
the information processing device
   acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus, and
   specifies the first actual value indicated by the first actual value information included in the first data as a first reference value after fixing the first data at the first fixed position, specifies the first actual value indicated by the first actual value information included in the second data as a second reference value after fixing the second data at the second fixed position, specifies one or more pieces of data excluding the first data and the second data among the data included in the list as comparison target data, specifies the first actual value indicated by the first actual value information included in each piece of the comparison target data as a comparison target value, and displays, for each of the one or more pieces of comparison target data, the comparison target value in a corresponding piece of the comparison target data according to a third display rule corresponding to the first reference value and the second reference value.
      [17]

The molding management system according to any one of [1] to [16], further including:
the terminal device.
   [18]

The molding management system according to any one of [1] to [17], further including:
the injection molding apparatus.

The embodiment of the present disclosure is described in detail above with reference to the drawings. However, a specific configuration is not limited to the embodiment and may be, for example, changed, replaced, or deleted without departing from the gist of the present disclosure.

A program for implementing a function of any component in the device described above may be recorded in a computer-readable recording medium and the program may be read and executed by a computer system. Here, the device is, for example, the injection molding apparatus 11, the information processing device 20, the server 30, or the terminal device 40. Here, the “computer system” referred to here includes an operating system (OS) and hardware such as peripheral devices. The “computer-readable recording medium” refers to a portable medium such as a flexible disc, a magneto-optical disc, a ROM, or a compact disk (CD) ROM or a storage device such as a hard disk built in the computer system. Further, the “computer-readable recording medium” includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system for managing production of a product in a production process including an injection molding process of the product performed by an injection molding apparatus, the molding management system comprising:
an information processing device communicably connected to a terminal device, wherein
the information processing device
acquires data including a plurality of types of information related to injection molding from the injection molding apparatus,
displays a list of the data on a display unit in response to a first operation that is received, and
fixes, in response to a second operation that is received, a position of first data designated by the second operation among the data included in the list at a first fixed position designated by the second operation, after the list is displayed on the display unit.

2. The molding management system according to claim 1, wherein
the first fixed position is a position of the first data in the list at a time point when the second operation is received.

3. The molding management system according to claim 2, wherein
a relative position of the first fixed position relative to a frame of the list does not change even when the data is scrolled in the list.

4. The molding management system according to claim 3, wherein
after fixing the first data at the first fixed position, the information processing device changes the first fixed position in the list in response to a third operation that is received.

5. The molding management system according to claim 1, wherein
the first fixed position is a position outside the list.

6. The molding management system according to claim 1, wherein
after the list is displayed, the information processing device displays, in response to a received operation, an extraction condition reception image for receiving an extraction condition for extracting the first data from the data, receives, as the second operation, an operation of receiving the extraction condition via the displayed extraction condition reception image, and specifies, as the first data, the data extracted according to the extraction condition received by the second operation.

7. The molding management system according to claim 1, wherein
the information processing device acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus.

8. The molding management system according to claim 7, wherein
after fixing the first data at the first fixed position, the information processing device specifies the first actual value indicated by the first actual value information included in the first data as a first reference value, specifies one or more pieces of data excluding the first data among the data included in the list as comparison target data, specifies the first actual value indicated by the first actual value information included in each piece of the comparison target data as a comparison target value, and displays, for each of the one or more pieces of comparison target data, the comparison target value in a corresponding piece of comparison target data according to a predetermined display rule.

9. The molding management system according to claim 8, wherein
the display rule is a rule of displaying the comparison target value in a color different from a color of the first reference value when the comparison target value is a value different from the first reference value.

10. The molding management system according to claim 8, wherein
the display rule is a rule of displaying, when the comparison target value is a value different from the first reference value, an image indicating that the comparison target value is different from the first reference value, in association with the comparison target value.

11. The molding management system according to claim 10, wherein
the image varies in design depending on a difference between the comparison target value and the first reference value.

12. The molding management system according to claim 8, wherein
the display rule is a rule of displaying the comparison target value by a difference with the first reference value.

13. The molding management system according to claim 8, wherein
the display rule is a rule of displaying the comparison target value by a ratio to the first reference value.

14. The molding management system according to claim 1, wherein
after fixing the first data at the first fixed position, the information processing device fixes, in response to a fourth operation that is received, a position of second data designated by the fourth operation among the data included in the list at a second fixed position designated by the second operation,
the second data is that in the data, which is different from the first data, and
the second fixed position is a position different from the first fixed position.

15. The molding management system according to claim 14, wherein
the information processing device
acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus, and
specifies the first actual value indicated by the first actual value information included in the first data as a first reference value after fixing the first data at the first fixed position, specifies the first actual value indicated by the first actual value information included in the second data as a second reference value after fixing the second data at the second fixed position, specifies one or more pieces of data excluding the first data among the data included in the list as first comparison target data, specifies one or more pieces of data excluding the second data among the data included in the list as second comparison target data, specifies the first actual value indicated by the first actual value information included in each piece of the first comparison target data as a first comparison target value, specifies the first actual value indicated by the first actual value information included in each piece of the second comparison target data as a second comparison target value, displays, for each of the one or more pieces of first comparison target data, the first comparison target value in a corresponding piece of the first comparison target data according to a predetermined first display rule corresponding to the first reference value, and displays, for each of the one or more pieces of second comparison target data, the second comparison target value in a corresponding piece of the second comparison target data according to a predetermined second display rule corresponding to the second reference value, and
the second display rule is a rule different from the first display rule.

16. The molding management system according to claim 14, wherein
the information processing device
acquires cycle data as the data from the injection molding apparatus for each cycle of performing injection molding, the cycle data including, as cycle-related information obtained in response to execution of the cycle by the injection molding apparatus, first actual value information indicating a first actual value controlled by the injection molding apparatus and including first date-and-time information indicating a date and time when the cycle data is acquired from the injection molding apparatus, and
specifies the first actual value indicated by the first actual value information included in the first data as a first reference value after fixing the first data at the first fixed position, specifies the first actual value indicated by the first actual value information included in the second data as a second reference value after fixing the second data at the second fixed position, specifies one or more pieces of data excluding the first data and the second data among the data included in the list as comparison target data, specifies the first actual value indicated by the first actual value information included in each piece of the comparison target data as a comparison target value, and displays, for each of the one or more pieces of comparison target data, the comparison target value in a corresponding piece of the comparison target data according to a third display rule corresponding to the first reference value and the second reference value.

17. The molding management system according to claim 16, wherein
the third display rule is a rule of displaying the comparison target value in a color different from colors of the first reference value and the second reference value when the comparison target value is a value outside a range in which a larger reference value of the first reference value and the second reference value is set as an upper limit value and a smaller reference value of the first reference value and the second reference value is set as a lower limit value.

18. The molding management system according to claim 1, further comprising:
the terminal device.

19. The molding management system according to claim 1, further comprising:
the injection molding apparatus.
